(19) United States
(12) Patent Application Publication
(10) Pub. No.: US 2025/0049275 A1
(43) Pub. Date: Feb. 13, 2025

(54) DUST COLLECTING ATTACHMENT

(71) Applicant: MAKITA CORPORATION, Anjo-shi (JP)

(72) Inventors: Bang Wang, Jiangsu (CN); Xiongfei Wen, Jiangsu (CN); Yoshiro Tada, Anjo-shi (JP); Takahiro Nishikawa, Anjo-shi (JP)

(73) Assignee: MAKITA CORPORATION, Anjo-shi (JP)

(21) Appl. No.: 18/764,797

(22) Filed: Jul. 5, 2024

(30) Foreign Application Priority Data
Aug. 10, 2023 (JP) 2023-131431
May 15, 2024 (JP) 2024-079689

(51) Int. Cl. A47L 7/00; B23Q 11/00; B25D 17/20

(52) U.S. Cl. CPC A47L 7/0095; B23Q 11/0046; B25D 17/20

(57) ABSTRACT

A dust collecting attachment includes a dust suction portion and a main body. The dust suction portion has a suction opening through which a tip tool is allowed to pass. The main body has a dust collection passage communicated with the dust suction portion and connectable to an external hose. The main body includes a suction space, an air vent hole, and an air vent operation portion. The suction space is communicated with the dust collection passage and has a suction port opening to a workpiece. The air vent hole opens the suction space to outside. The air vent operation portion normally closes the air vent hole and opens the air vent hole by a predetermined operation. The air vent operation portion is operated together with an operation of removing the main body from the workpiece to open the air vent hole.

### CROSS REFERENCE TO RELATED APPLICATION

This application claims the benefit of Japanese Patent Application Numbers 2023-131431 filed on Aug. 10, 2023 and 2024-079689 filed on May 15, 2024, the entirety of which is incorporated by reference.

### FIELD OF THE INVENTION

The present disclosure relates to a dust collecting attachment used for collecting dust generated from a workpiece during work with a power tool such as a hammer drill.

### BACKGROUND OF THE INVENTION

When a drilling work and the like is performed with a mounted tip tool using a hammer drill and the like, a dust collecting attachment is sometimes used to collect dust generated from a workpiece at a machining position without scattering it. One example is disclosed in US 2011/0142564 A. The dust collecting attachment disclosed here includes a housing that extends to the right and left, and a cylindrical dust suction portion, through which a tip tool passes, at the top of the housing. A cylindrical handle portion, which has a dust collection passage communicated with the dust suction portion, is formed on the front side of the housing, and a suction space, which has a suction port with an opening, is formed on the back side of the housing.

The dust collecting attachment is used by connecting an external dust collector to the handle portion via a hose. When the dust collector is operated and the suction port is brought into contact with a surface of the workpiece, the handle portion and the dust suction portion communicated with the hose become negative pressure, and the suction space communicated with the handle portion also becomes negative pressure. Therefore, the suction port is positioned by adhering to the workpiece by suctioning. When the tip tool of the power tool is inserted into the dust suction portion for machining, the generated dust is suctioned directly from the dust suction portion and collected in the dust collector through the handle portion and the hose.

Air vent holes are formed on the right and left sides of the handle portion, each of which is communicated with the suction space. Each of the air vent holes includes a button that normally closes the air vent hole.

When removing the dust collecting attachment from the workpiece to change the machining position or the like, the operator pushes in the right and left buttons with his/her fingers to open the air vent holes. Then, since outside air flows into the suction space and the suction force is reduced, the dust collecting attachment can be removed from the workpiece.

In the conventional dust collecting attachment described above, when removing the attachment, the operation is to pull it toward the front, which intersects the right-left direction, while maintaining the operation of pushing the buttons in from the right-left direction. In other words, the two operations are required, which is not easy to operate.

In addition, since the direction in which the button is pushed in is different from the direction in which the dust collecting attachment is pulled, there is a risk of accidentally dropping the dust collecting attachment when removing it when working against a vertical wall and the like.

Therefore, it is an object of the disclosure to provide a dust collecting attachment that can be removed by simple operation and can also effectively avoid unintentional dropping during removal.

### SUMMARY OF THE INVENTION

In order to achieve the above-described object, the present disclosure provides a dust collecting attachment including a dust suction portion and a main body. The dust suction portion has a suction opening through which a tip tool is allowed to pass. The main body has a dust collection passage communicated with the dust suction portion and connectable to an external hose. The main body includes a suction space, an air vent hole, and an air vent operation portion. The suction space is communicated with the dust collection passage and has a suction port opening to a workpiece. The air vent hole opens the suction space to outside. The air vent operation portion normally closes the air vent hole and opens the air vent hole by a predetermined operation. The air vent operation portion is operated together with an operation of removing the main body from the workpiece to open the air vent hole.

With the present disclosure, the air vent by the air vent operation portion and the removal of the dust collecting attachment are not separate operations. Therefore, the dust collecting attachment can be removed by a simple operation, and unintentional dropping of the dust collecting attachment during removal can be effectively avoided.

### BRIEF DESCRIPTION OF THE DRAWINGS

FIG. 1 is a rear perspective view of a dust collecting attachment of a first embodiment.

FIG. 2 is a front perspective view of the dust collecting attachment of the first embodiment.

FIG. 3 is a rear view of the dust collecting attachment of the first embodiment.

FIG. 4 is an enlarged cross-sectional view of the line A-A in FIG. 3.

FIG. 5 is an enlarged cross-sectional view of the line B-B in FIG. 3.

FIG. 6 is a partial enlarged cross-sectional view of the line C-C in FIG. 3.

FIG. 7 is an enlarged cross-sectional view of the line B-B with an air vent lever in operation.

FIG. 8 is a partial enlarged cross-sectional view of the line C-C with the air vent lever in operation.

FIG. 9 is a rear perspective view of a dust collecting attachment of a second embodiment.

FIG. 10 is a rear view of the dust collecting attachment of the second embodiment.

FIG. 11 is an enlarged cross-sectional view of the line D-D in FIG. 10.

FIG. 12 is a rear perspective view of a dust collecting attachment of a third embodiment.

FIG. 13 is a rear view of the dust collecting attachment of the third embodiment.

FIG. 14 is an enlarged cross-sectional view of the line E-E in FIG. 13.

FIG. 15 is a rear perspective view of a dust collecting attachment of a fourth embodiment.

FIG. 16 is a rear view of the dust collecting attachment of the fourth embodiment.

FIG. 17 is a front view of the dust collecting attachment of the fourth embodiment.

FIG. 18 is an enlarged cross-sectional view of the line F-F in FIG. 16.

FIG. 19 is an enlarged cross-sectional view of the line G-G in FIG. 16.

FIG. 20 is a rear perspective view of a dust collecting attachment of a fifth embodiment.

FIG. 21 is a rear view of the dust collecting attachment of the fifth embodiment.

FIG. 22 is an enlarged cross-sectional view of the line H-H in FIG. 21.

FIG. 23 is a rear perspective view of a dust collecting attachment of a sixth embodiment.

FIG. 24 is a front perspective view of the dust collecting attachment of the sixth embodiment.

FIG. 25 is a rear view of the dust collecting attachment of the sixth embodiment.

FIG. 26 is a front view of the dust collecting attachment of the sixth embodiment.

FIG. 27 is an enlarged cross-sectional view of the line I-I in FIG. 25.

FIG. 28 is a rear view of the dust collecting attachment of the sixth embodiment with a small diameter cuff connected.

FIG. 29 is a rear view of the dust collecting attachment of the sixth embodiment with a large diameter cuff connected.

FIG. 30 is a partial enlarged cross-sectional view of the line J-J in FIG. 28.

FIG. 31 is a partial enlarged cross-sectional view of the line K-K in FIG. 29.

FIG. 32 is an enlarged cross-sectional view of the line L-L in FIG. 29 in use.

### DETAILED DESCRIPTION OF THE INVENTION

In one embodiment of the present disclosure, an operating direction of the air vent operation portion may be the same as a direction in which the main body is removed from the workpiece.

With the configuration, the air vent operation by the air vent operation portion and the removal operation of the dust collecting attachment can be performed continuously and smoothly.

In one embodiment of the present disclosure, the air vent operation portion may include a finger hook portion.

With the configuration, the air vent operation by the air vent operation portion can be easily performed.

In one embodiment of the present disclosure, a portion of the dust collection passage may form a handle portion that bulges on a surface of the main body and extends in a straight line in a predetermined direction, and the air vent operation portion may be disposed on the handle portion.

With the configuration, the air vent operation by the air vent operation portion and the removal operation of the dust collecting attachment can be performed continuously with the hand that grasps the handle portion, thus eliminating the need for two-handed operation.

In one embodiment of the present disclosure, a pair of the air vent operation portions may be disposed on both sides of a center line of the handle portion.

With the configuration, the air vent operation by the air vent operation portion and the removal operation of the dust collecting attachment can be performed in a well-balanced and reliable manner.

In one embodiment of the present disclosure, the pair of air vent operation portions may be connected as one unit.

With the configuration, the timings for opening the air vent holes are simultaneous. Therefore, the dust collecting attachment does not rotate or tilt when the dust collecting attachment is removed, and the dust collecting attachment can be operated in a well-balanced manner.

In one embodiment of the present disclosure, the air vent operation portion may be disposed at one location.

With the configuration, the number of parts can be reduced and the manufacturing cost can be kept down even when the air vent operation portion is provided.

In one embodiment of the present disclosure, the air vent operation portion may be disposed on any one of both sides of a center line of the handle portion, and the finger hook portion is disposed on the handle portion on an opposite side of the air vent operation portion across the handle portion.

With the configuration, even with the one air vent operation portion, the pair of finger hook portions do not impair the operability during the removal.

In one embodiment of the present disclosure, the external hose may be connectable to the handle portion.

With the configuration, even when the hose is connected, it can be supported stably by the handle portion, and the hose is less likely to get in the way of work.

In one embodiment of the present disclosure, the air vent operation portion does not have to protrude from an outer shape of the handle portion except for the finger hook portion when the air vent hole is closed.

With the configuration, even with the air vent operation portion, the usability of the handle portion is not impaired and is less likely to interfere with the power tool.

In one embodiment of the present disclosure, the air vent operation portion may include a handle.

With the configuration, the air vent operation by the air vent operation portion and the removal operation of the dust collecting attachment can be performed more easily by using the handle.

In one embodiment of the present disclosure, the main body may include a main body housing having the dust collection passage and the suction space and a pad made of elastic material, disposed on the main body housing, and protruding to a side of the workpiece to form the suction port.

The main body housing may include a contact portion protruding to the side of the workpiece and contacting the workpiece in a state where the suction port is suctioned to the workpiece.

With the configuration, any unevenness on the surface of the workpiece can be absorbed by the deformation of the pad, thus restricting the main body housing from lifting and reducing the suction force.

In one embodiment of the present disclosure, when the suction port is not suctioned to the workpiece, a protruding surface of the contact portion at the side of the workpiece may be positioned on a same plane as the protruding surface of the pad at the side of the workpiece or at a side of the main body housing with respect to the protruding surface of the pad.

With the configuration, the contact portion does not inhibit the pad from closely contacting the surface of the workpiece.

The following describes embodiments of the disclosure based on the drawings.

A first embodiment of the disclosure is provided below.

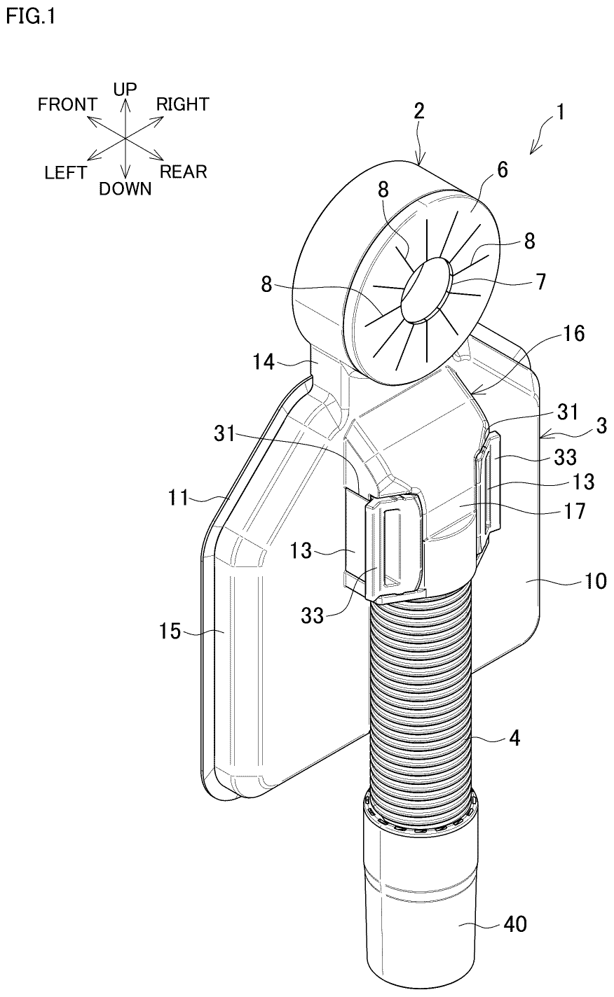

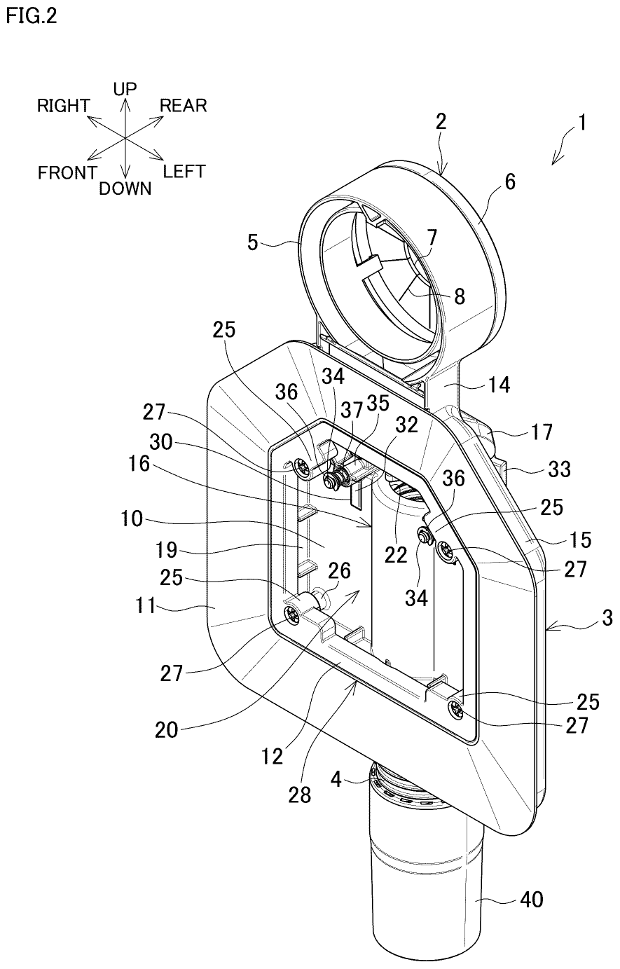

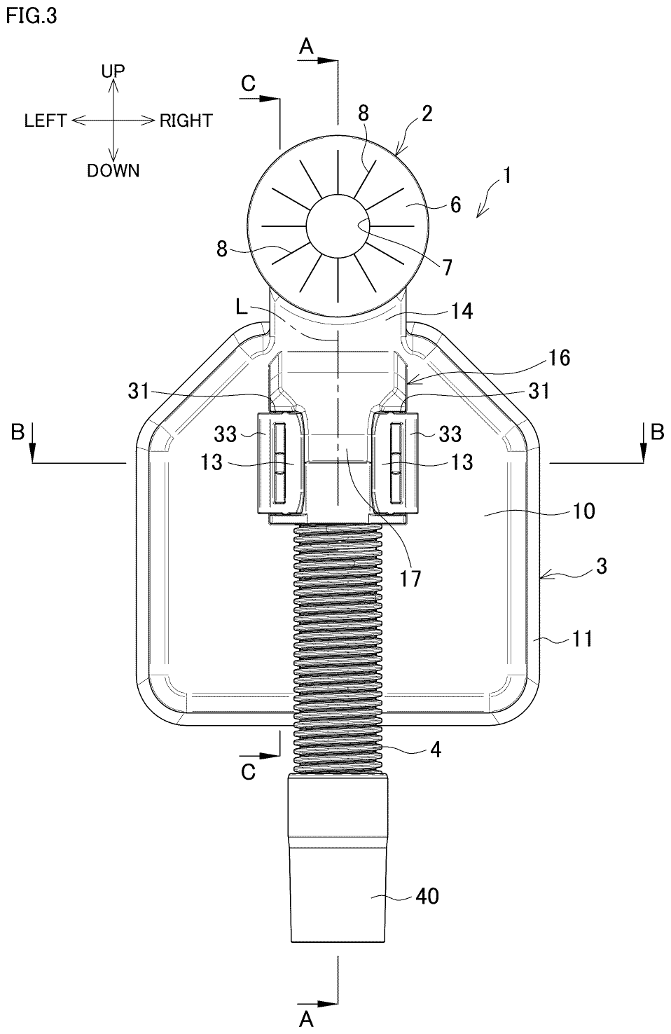

FIG. 1 is a rear perspective view illustrating one example of a dust collecting attachment, FIG. 2 is a front perspective view thereof, and FIG. 3 is a rear view thereof. A dust collecting attachment 1 includes a dust suction portion 2, a main body 3, and a flexible hose 4. For convenience, the dust suction portion 2 is described as the upper side, and a suction opening 5 and a suction port 28 described later in the dust suction portion 2 and the main body 3 are described as the front side.

The dust suction portion 2 is cylindrical with its axis extending in a front-rear direction. The dust suction portion 2 has a front surface where the suction opening 5 opens. A rubber cap 6 is attached to a rear surface of the dust suction portion 2. The rubber cap 6 has a through hole 7 positioned in the center and a plurality of cuts 8 extending radially from the through hole 7.

The main body 3 includes a main body housing 10, a pad 11, an inner frame 12, and an air vent lever 13.

The main body housing 10 extends in the right-left direction as viewed from the rear and has a polygonal shape in which the top is trapezoidal and the bottom is rectangular. At the top of the main body housing 10, a joining portion 14 joined with the dust suction portion 2 is provided in an up-down direction. On an outer circumference of the main body housing 10, a band-shaped skirt portion 15 protruding forward across the entire circumference is formed, and the front thereof is open.

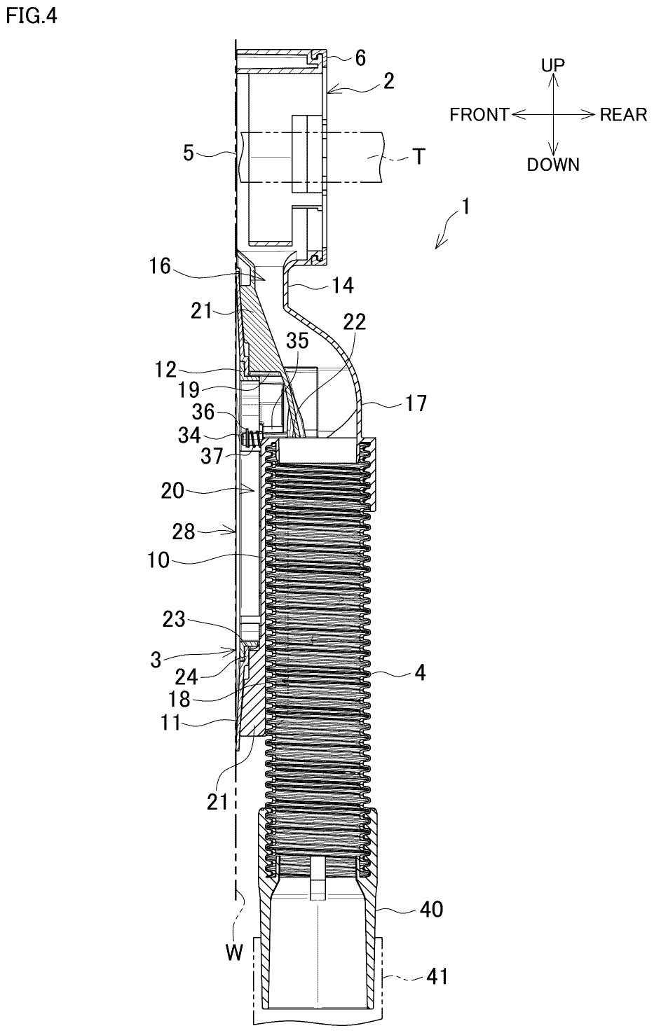

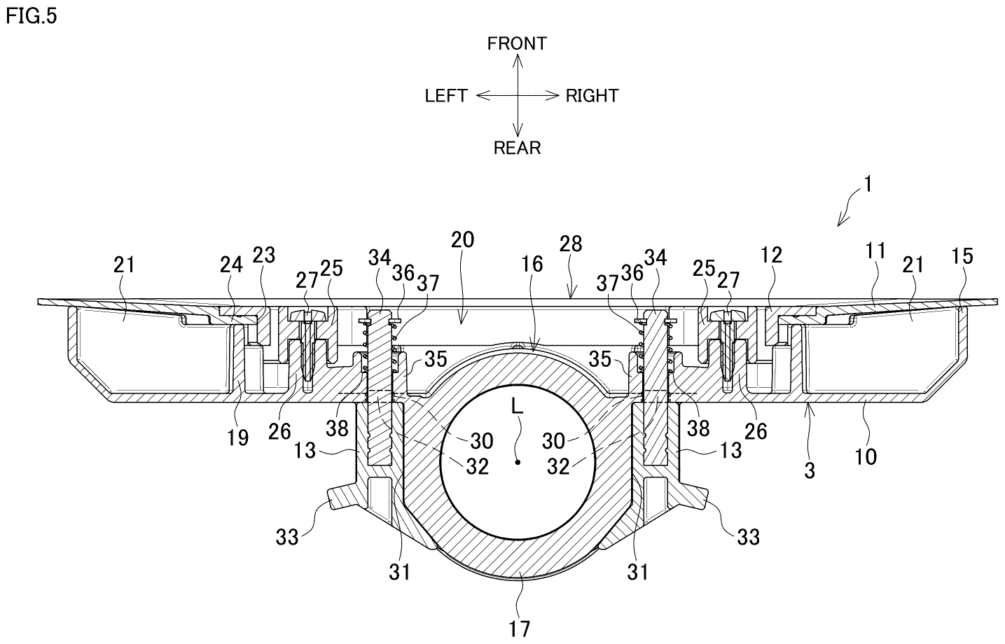

A cylindrical dust collection passage 16 is formed in the main body housing 10 in the up-down direction, for example, as illustrated in FIGS. 4 and 5. The dust collection passage 16 passes through the joining portion 14 at the center of the main body housing 10 in the right-left direction and opens at its upper end to a lower inner surface of the dust suction portion 2. A lower portion of the dust collection passage 16 bulges rearward from the upper part to the lower part of the main body housing 10 to form a handle portion 17, which opens at its lower end on the rear surface of the main body housing 10. On the rear surface of the main body housing 10, a semi-circular recess 18 in cross section extending continuously from the handle portion 17 to the lower side is formed.

On a front surface of the main body housing 10, an inner rib 19 having the same shape that is smaller than the skirt portion 15 is formed. A suction space 20 is formed inside the inner rib 19. A plurality of connecting ribs 21 protruding radially from the inner rib 19 are bridged between the skirt portion 15 and the inner rib 19. A communication port 22 is formed at a front upper end of the handle portion 17, which is communicated with the suction space 20.

The pad 11 is made of elastic material and has a similar outer shape, slightly larger as viewed from the front than the main body housing 10. At the center of the pad 11, an opening 23 that has the same shape along the inner rib 19 is formed. The pad 11 is positioned in front of the main body housing 10 so as to cover a space between the skirt portion 15 and the inner rib 19. The pad 11 has a shallow tapered shape with the front surface receding from the outer circumference to the opening 23 side. On an inner edge of the opening 23, a thin walled portion 24 that is recessed rearward across the entire circumference is formed.

The inner frame 12 is ring-shaped, fitting into the thin walled portion 24 of the pad 11 and circumferentially runs along the thin walled portion 24. A pair of right and left screw receivers 25 are formed on an inner circumference of the inner frame 12 at the top and the bottom thereof, respectively. The screw receivers 25 are fixed to screw bosses 26 with respective screws 27. The screw bosses 26 are disposed upright on each of the pair of right and left in the upper and lower sides of the front surface of the main body housing 10. This secures the pad 11 and forms the suction port 28, which is communicated with the suction space 20 at the center, on a front surface of the pad 11 and the inner frame 12.

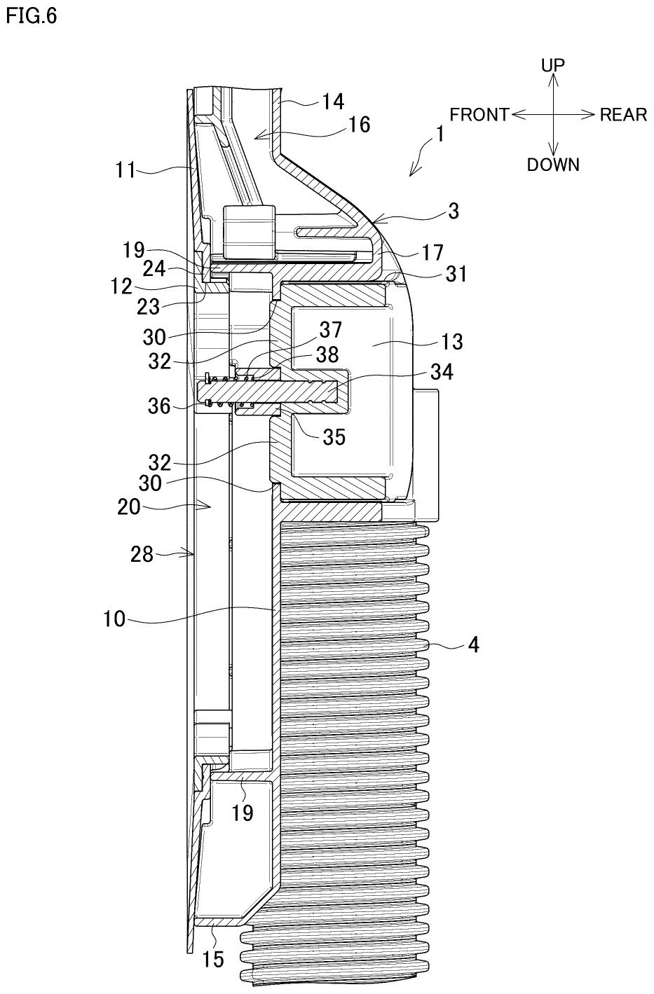

In the main body housing 10, air vent holes 30 facing into the suction space 20 are formed. The air vent holes 30 are rectangular in shape extending in the up-down direction and are arranged in the up-down direction, two on each of the right and left side between the upper right and left screw bosses 26, as illustrated in FIGS. 5 and 6.

The right and left air vent holes 30 are positioned on the right and left sides of the handle portion 17 on the rear side. A pair of cutouts 31, which span from the side to the rear side, are formed on the right and left sides of the handle portion 17. Each cutout 31 extends in the up-down direction in a square-shaped area that includes the upper and lower air vent holes 30. The air vent holes 30 penetrate the main body housing 10 and are communicated with the cutouts 31.

The air vent levers 13 are square block-shaped levers that fit into the cutouts 31 and span from the sides to the rear surface of the handle portion 17. As illustrated in FIGS. 3 and 5, the air vent levers 13 are right-left symmetrically positioned around the center line L of the handle portion 17 and can move back and forth within the cutouts 31. On a front surface of each air vent lever 13, a pair of upper and lower closure portions 32 are protruded as illustrated in FIG. 6. The closure portions 32 fit into the air vent holes 30 and close the air vent holes 30 at a forward position in contact with a bottom surface of the cutout 31.

Each air vent lever 13 fits into the cutout 31 in the forward position and fits within the outer shape of the handle portion 17. However, between the side surface and the rear surface of each air vent lever 13, a finger hook piece 33 extending right and left outward and rearward at an angle is formed in one piece in the up-down direction.

The air vent lever 13 is an example of an air vent operation portion of the present disclosure. The finger hook piece 33 is one example of a finger hook portion of the present disclosure.

Each air vent lever 13 includes a forward protruding guide pin 34. Each guide pin 34 is integrally fixed to the air vent lever 13 at the rear between the closure portions 32 by insert molding. Between the upper and lower air vent holes 30 in the main body housing 10, respective guide tubes 35 protruding forward are formed. Each guide pin 34 penetrates the guide tube 35 from the rear. A circlip 36 is attached to a front end of each guide pin 34 in front of the guide tube 35.

A coil spring 37 is externally mounted on a front portion of each guide pin 34 in front of each guide tube 35. The coil spring 37 is interposed between a receiving recess 38 formed in the inner circumference of the guide tube 35 and the circlip 36. Thus, since the guide pin 34 is biased forward by the coil spring 37, each air vent lever 13 is normally positioned in the forward position where the closure portions 32 close the air vent holes 30.

The flexible hose 4 is connected at its upper end to the handle portion 17 of the main body housing 10. The flexible hose 4 fits into the recess 18 of the main body housing 10 and extends downward. A tubular joint 40 is attached to a lower end of the flexible hose 4.

To use the dust collecting attachment 1 configured as described above, the operator connects an external hose 41, which is connected to a dust collector not illustrated, to the joint 40 of the flexible hose 4 connected to the handle portion 17 as illustrated in FIG. 4. The operator then grasps the handle portion 17 of the main body 3, aligns the dust suction portion 2 with the machining position, positions the main body 3 on a surface of the workpiece W in the vertical direction, and places the suction port 28 in close contact with the workpiece W. When the dust collector is operated in this state, suction force is generated in the flexible hose 4 and the dust collection passage 16 via the hose 41, and the suction force is generated also in the suction opening 5 of the dust suction portion 2, which is communicated with the dust collection passage 16.

Since the suction space 20 of the main body 3 is communicated with the dust collection passage 16 via the communication port 22, the air in the suction space 20 is suctioned into the dust collection passage 16 via the communication port 22, thus resulting in a negative pressure in the suction space 20. Therefore, the suction port 28 adheres to the surface of the workpiece W by suctioning, and the dust collecting attachment 1 is fixed to the surface of the workpiece W.

The operator performs drilling or other operations by penetrating a tip tool T of a power tool, not illustrated, from the rear of the dust suction portion 2. The dust generated from the workpiece W is then suctioned into the dust suction portion 2 from the suction opening 5 together with air, and is collected at the dust collector from the dust collection passage 16 through the flexible hose 4 and the hose 41.

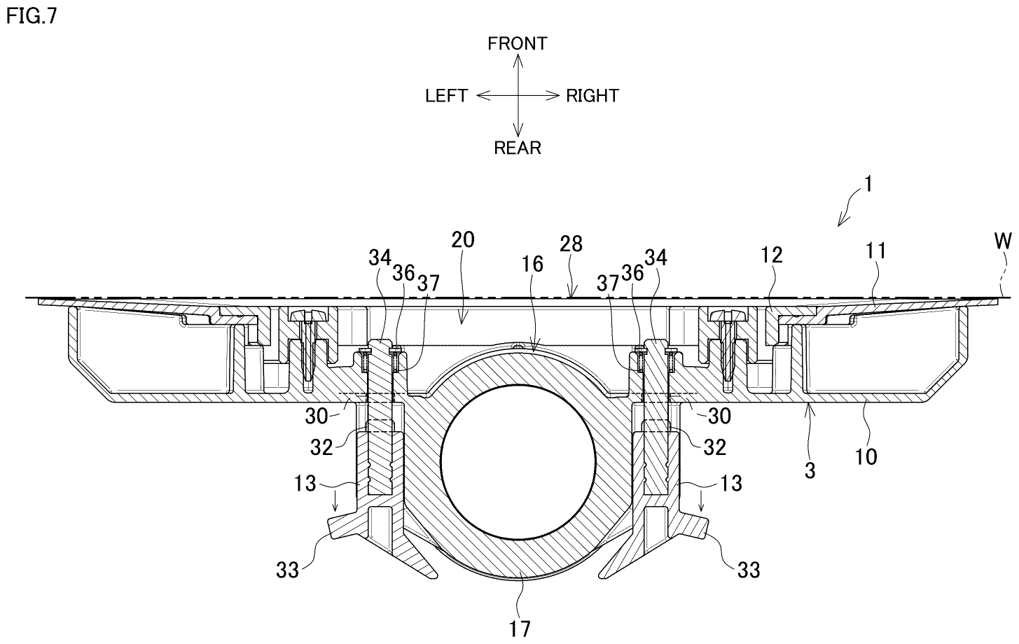

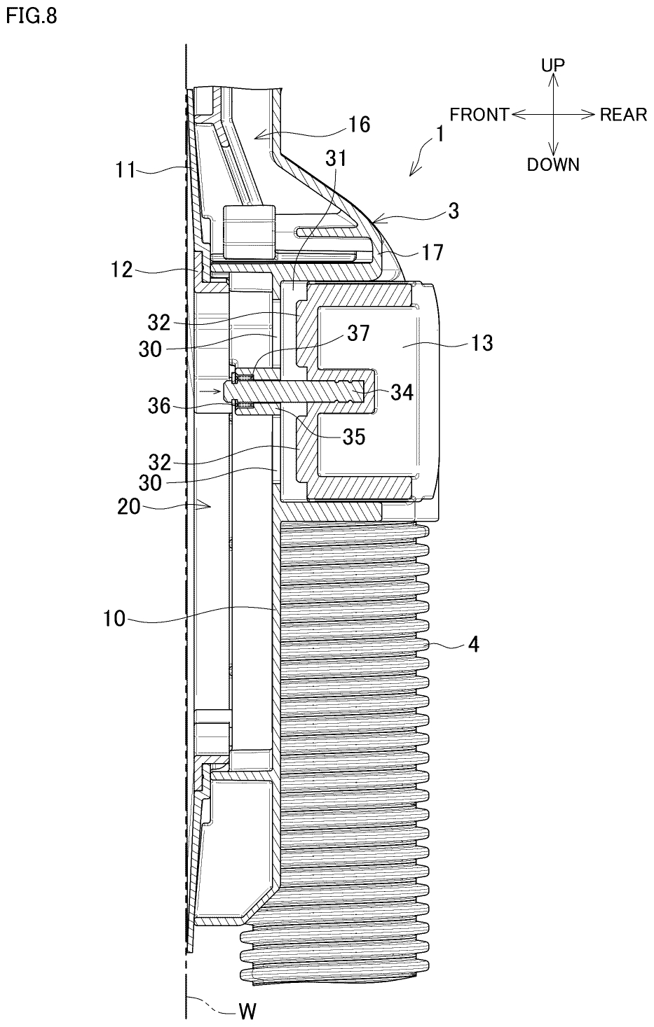

When removing the dust collecting attachment 1 from the workpiece W to change the machining position or the like, the operator hooks his/her fingers on the finger hook pieces 33 of the right and left air vent levers 13 on the handle portion 17 from the front side and pulls them rearward as it is. Then, as illustrated in FIGS. 7 and 8, the air vent levers 13 retract against the biasing of the coil springs 37 and open the right and left cutouts 31 for opening the respective air vent holes 30. Then, since outside air flows into the suction space 20 through each air vent hole 30 while the suction force decreases, the dust collecting attachment 1 can be removed rearward from the workpiece W. This removal can be performed continuously with the operation of pulling the air vent levers 13 rearward via the finger hook pieces 33.

When the dust collecting attachment 1 is removed and the pull on the air vent levers 13 is released, the air vent levers 13 move to the forward position by the biasing of the coil springs 37. Therefore, the air vent holes 30 are closed again by the closure portions 32.

The dust collecting attachment 1 of the above-described first embodiment includes the dust suction portion 2 having the suction opening 5 through which the tip tool T can pass, and the main body 3 having the dust collection passage 16 that is communicated with the dust suction portion 2 and is connectable to the external hose 41.

The main body 3 includes the suction space 20 that is communicated with the dust collection passage 16 and has the suction port 28 opening to the workpiece W, the air vent hole 30 that opens the suction space 20 to the outside, and the air vent lever 13 that normally closes the air vent hole 30 and opens the air vent hole 30 by a predetermined operation.

The air vent lever 13 is operated together with an action of removing the main body 3 from the workpiece W to open the air vent hole 30.

With the configuration, the air vent by the air vent lever 13 and the removal of the dust collecting attachment 1 are not separate operations. Therefore, the dust collecting attachment 1 can be removed with a simple operation, and unintentional dropping thereof during the removal can be effectively avoided.

The operating direction of the air vent lever 13 is the same as the direction in which the main body 3 is removed from the workpiece W.

Therefore, the air vent operation by the air vent lever 13 and the removal operation of the dust collecting attachment 1 can be performed continuously and smoothly.

The finger hook piece 33 is disposed on the air vent lever 13.

Therefore, the air vent operation by the air vent lever 13 can be easily performed.

A portion of the dust collection passage 16 bulges onto a surface of the main body 3 to form the handle portion 17 that extends in a straight line in the up-down direction, and the air vent lever 13 is disposed on the handle portion 17.

Therefore, the air vent operation by the air vent lever 13 and the removal operation of the dust collecting attachment 1 can be performed continuously with the hand that grasps the handle portion 17, thus eliminating the need for the two-handed operation.

The pair of air vent levers 13 are disposed on both right and left sides of the center line L of the handle portion 17, in this case, at a line-symmetrical position.

Therefore, the air vent operation by the air vent lever 13 and the removal operation of the dust collecting attachment 1 can be performed in a well-balanced and reliable manner.

The external hose 41 is connectable to the handle portion 17 via the flexible hose 4.

Thus, even when the hose 41 is connected, it can be supported stably by the handle portion 17, and the hose 41 is less likely to get in the way of the work.

The air vent lever 13 does not protrude from the outer shape of the handle portion 17 except for the finger hook piece 33 when the air vent hole 30 is closed.

Therefore, even with the air vent lever 13, the usability of the handle portion 17 is not impaired and is less likely to interfere with the power tool.

In the above-described first embodiment, the following modification can be made.

The structure for closing the air vent holes by the air vent levers is not limited to the above example. For example, the guide pin disposed on each of the air vent levers on the right and left sides may be upper and lower two guide pins, instead of one guide pin, and one closure portion may be formed between the guide pins and to close one air vent hole in the main body housing. The guiding of the air vent lever is not limited to the one by the guide pin, but a plate-shaped guide portion may be disposed on the air vent lever. The guide portion may be formed as an integral portion of the air vent lever.

The shapes of the air vent holes and the closure portions can also be modified as needed. The air vent holes and the closure portions may be square, circular, or the like, instead of rectangular.

The shape of the air vent operation portion is also not limited to the square block-shaped air vent lever of the above example. The air vent operation portion may be semi-circular block-shaped or rod-shaped.

The finger hook portion does not have to be formed with the same amount of extension in the up-down direction as the finger hook piece in the above example. For example, the finger hook portion may be shaped as a semicircle as viewed from the rear, with a larger extension amount in the center of the up-down direction.

The finger hook portion does not have to have a structure that protrudes from the air vent operation portion like the finger hook piece in the above example. For example, the finger hook portion may be a recess formed in the air vent operation portion.

Other embodiments of this disclosure are described below.

A second embodiment of the disclosure is provided below. However, the same reference numerals are given to the components identical to those of the above-described first embodiment, and redundant explanations are omitted. The different configurations are mainly described below.

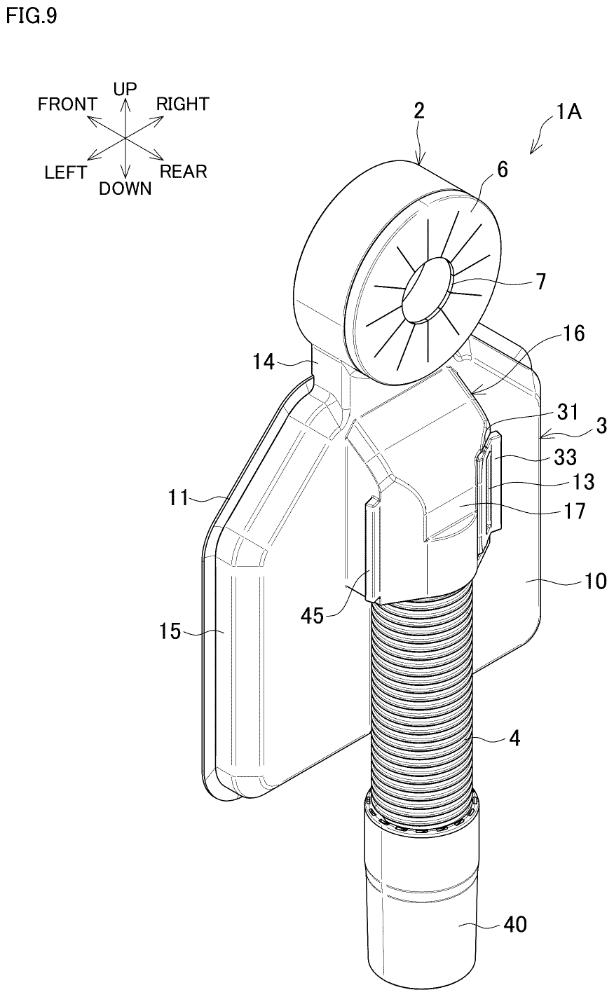

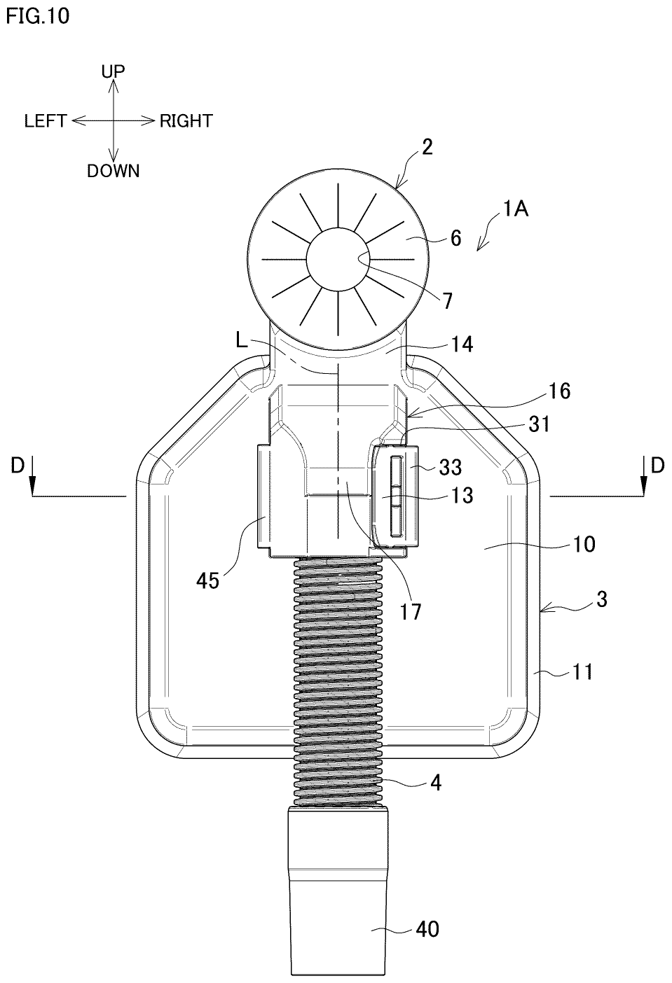

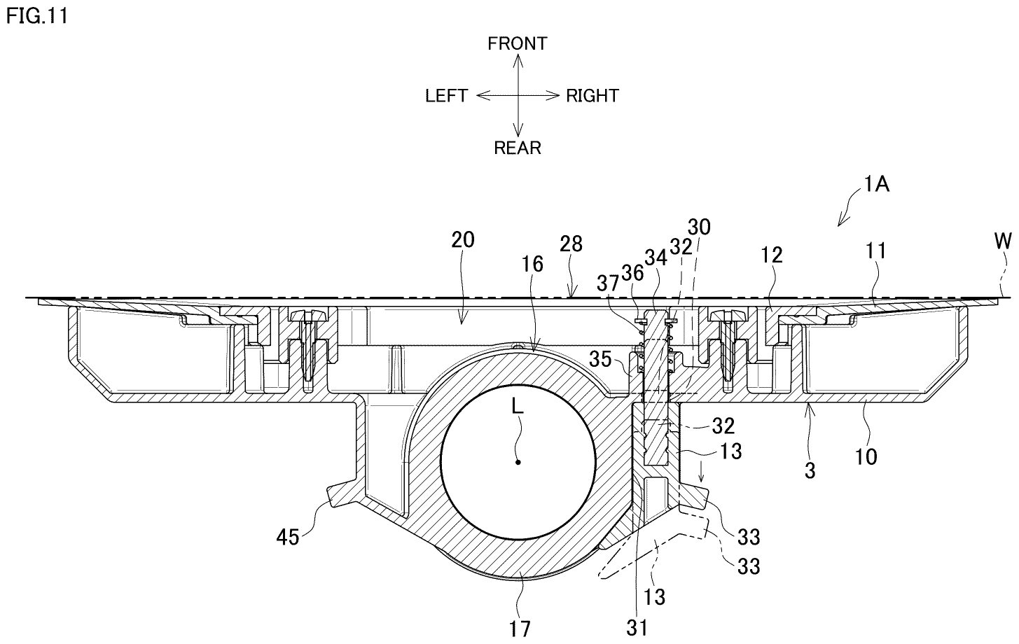

FIG. 9 is a rear perspective view of one example of a dust collecting attachment 1A of the second embodiment, FIG. 10 is a rear view thereof, and FIG. 11 is an enlarged cross-sectional view of the line D-D in FIG. 10.

The dust collecting attachment 1A differs from that of the first embodiment in that the air vent hole 30 is disposed only on the right side instead of those in the pair of right and left. Therefore, in the handle portion 17, the cutout 31 and the air vent lever 13 are disposed only on the right side. On a left side surface of the handle portion 17, a similar finger hook piece 45 is formed at a symmetrically opposite position of the finger hook piece 33 of the air vent lever 13 on the right side around the up-down and front-rear direction plane passing through the center line L. Other structures are the same as those in the first embodiment above.

Therefore, when removing the dust collecting attachment 1A from the workpiece W to change the machining position or the like, the operator hooks his/her fingers on the finger hook piece 33 of the air vent lever 13 on the right side of the handle portion 17 and the finger hook piece 45 of the handle portion 17 from the front side, and pulls them rearward as it is. Then, as illustrated by the double-dotted line in FIG. 11, the right side air vent lever 13 retracts against the biasing of the coil spring 37 and opens the right side cutout 31 for opening the respective air vent holes 30. Then, since outside air flows into the suction space 20 through each air vent hole 30 while the suction force decreases, the dust collecting attachment 1A can be removed rearward from the workpiece W. This removal can be performed continuously with the operation of pulling the air vent lever 13 rearward via the finger hook piece 33.

Also in the dust collecting attachment 1A of the above-described second embodiment, the air vent by the air vent lever 13 and the removal of the dust collecting attachment 1A are not separate operations. Therefore, the dust collecting attachment 1A can be removed by a simple operation, and unintentional dropping thereof during the removal can be effectively avoided.

In particular, since the air vent lever 13 is disposed on one location, the number of parts can be reduced and manufacturing costs can be kept down compared with the first embodiment.

The air vent lever 13 is disposed on the right side of the center line L of the handle portion 17, and the finger hook piece 45 is disposed on the handle portion 17 at the opposite side of the air vent lever 13 across the handle portion 17.

Therefore, even when the air vent lever 13 is disposed at the single point, the right and left finger hook pieces 33 and 45 do not impair operability of the removal.

In the above-described second embodiment, the following modification can be made in addition to those applicable with the modification in the above-described first embodiment.

The air vent hole and the air vent lever may be disposed on the left side of the handle portion instead of the right side.

The shape of the finger hook portion disposed on the handle portion can also be modified as needed. The finger hook portion may have a different shape than the finger hook portion of the air vent lever, for example, it may be a recess.

A third embodiment of the disclosure is provided below.

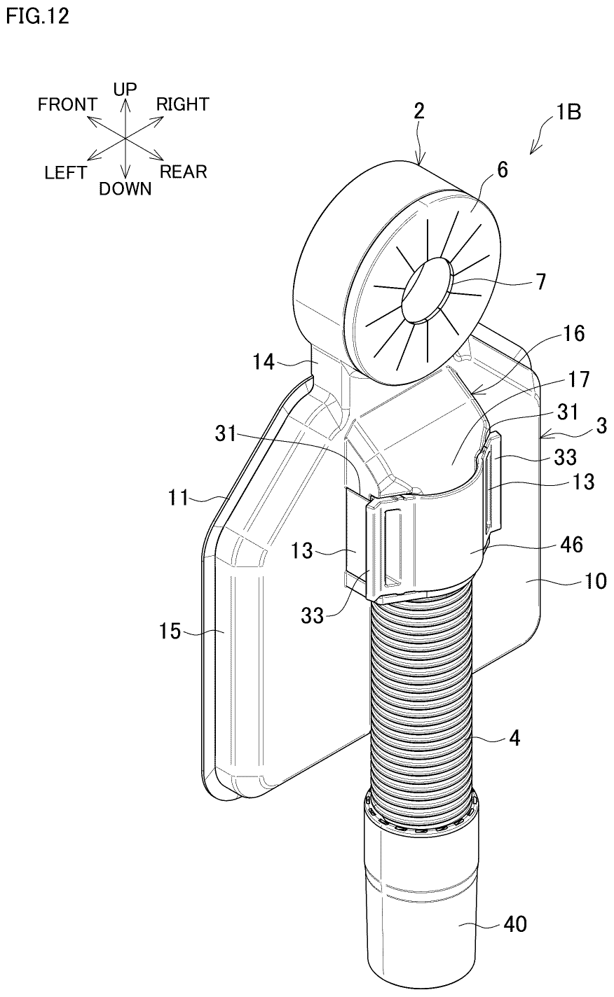

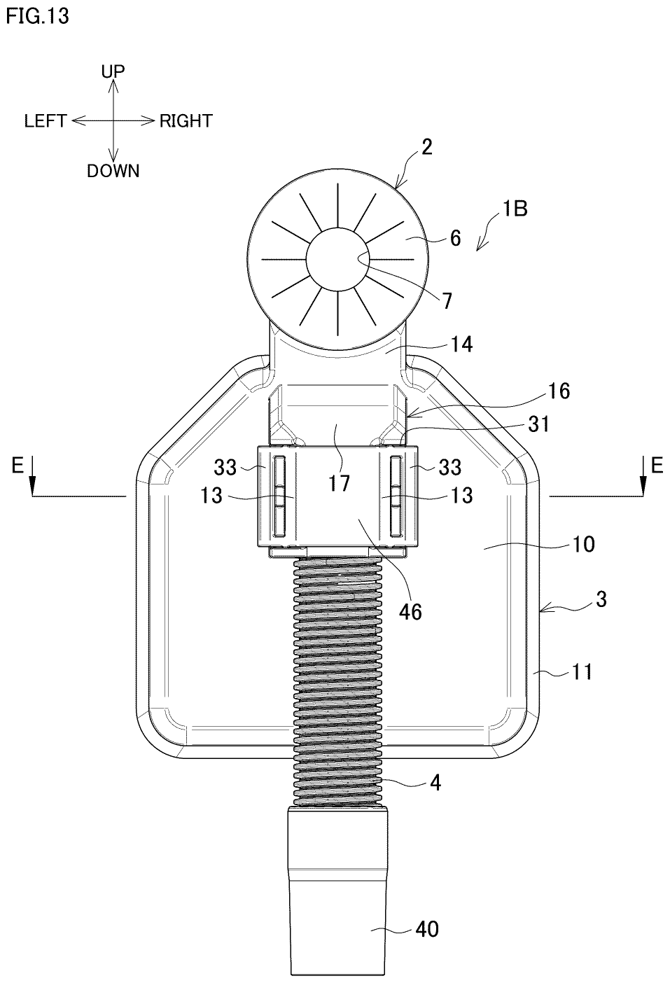

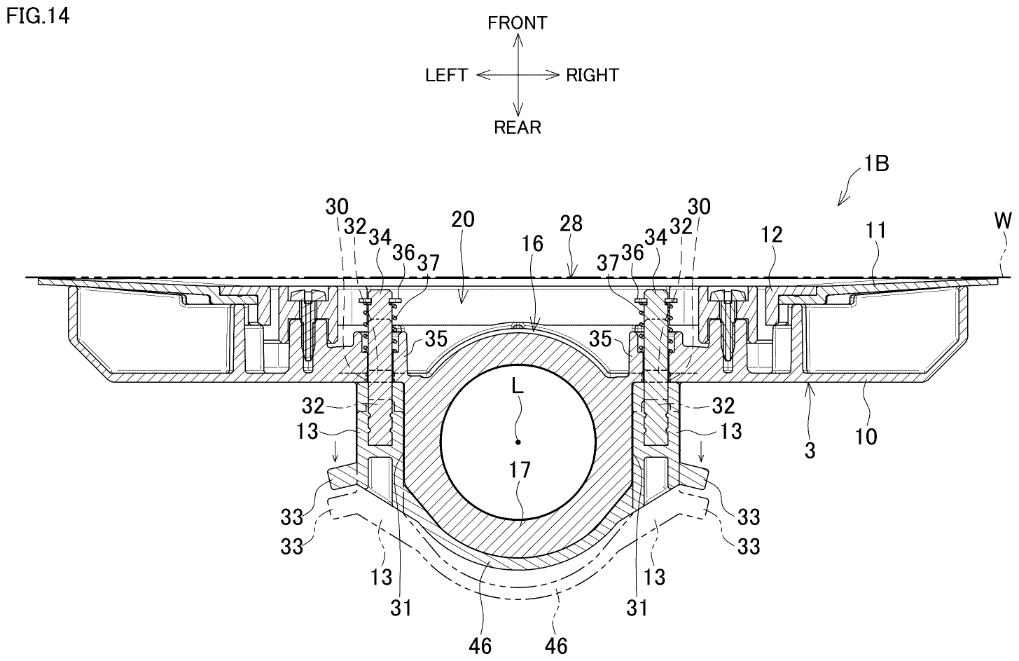

FIG. 12 is a rear perspective view illustrating one example of a dust collecting attachment 1B of the third embodiment, FIG. 13 is a rear view thereof, and FIG. 14 is an enlarged cross-sectional view of the line E-E in FIG. 13.

The dust collecting attachment 1B differs from that of the first embodiment in that the right and left air vent levers 13 are connected by a bridging portion 46. The bridging portion 46 is formed in an arc shape in plan view along an upper surface of the handle portion 17 with the same up-down width as the up-down width of the air vent levers 13. The bridging portion 46 is integrally molded with the right and left air vent levers 13.

When removing the dust collecting attachment 1B from the workpiece W to change the machining position or the like, the operator hooks his/her fingers on the finger hook pieces 33 of the right and left air vent levers 13 on the handle portion 17 from the front side and pulls them rearward as it is. Then, as illustrated by the double-dotted line in FIG. 14, the air vent levers 13 retract against the biasing of the coil springs 37 and open the right and left cutouts 31 for opening the respective air vent holes 30. Then, since outside air flows into the suction space 20 through each air vent hole 30 while the suction force decreases, the dust collecting attachment 1B can be removed rearward from the workpiece W. This removal can be performed continuously with the operation of pulling the air vent levers 13 rearward via the finger hook pieces 33.

Also in the dust collecting attachment 1B of the above-described third embodiment, the air vent by the air vent lever 13 and the removal of the dust collecting attachment 1B are not separate operations. Therefore, the dust collecting attachment 1B can be removed by a simple operation, and unintentional dropping thereof during the removal can be effectively avoided.

In particular, since the pair of air vent levers 13 are connected as one unit by the bridging portion 46, the timings for opening the air vent holes 30 are always simultaneous. Therefore, the dust collecting attachment 1B does not rotate or tilt when the dust collecting attachment 1B is removed, and can be operated in a well-balanced manner.

In the above-described third embodiment, the following modification can be made in addition to those applicable with the modifications in the above-described first embodiment.

The shape of the bridging portion can be modified as needed. For example, the bridging portion may be smaller or larger in the up-down width than the air vent lever.

The bridging portion may be formed by a separate component from the air vent lever.

A fourth embodiment of the disclosure is provided below.

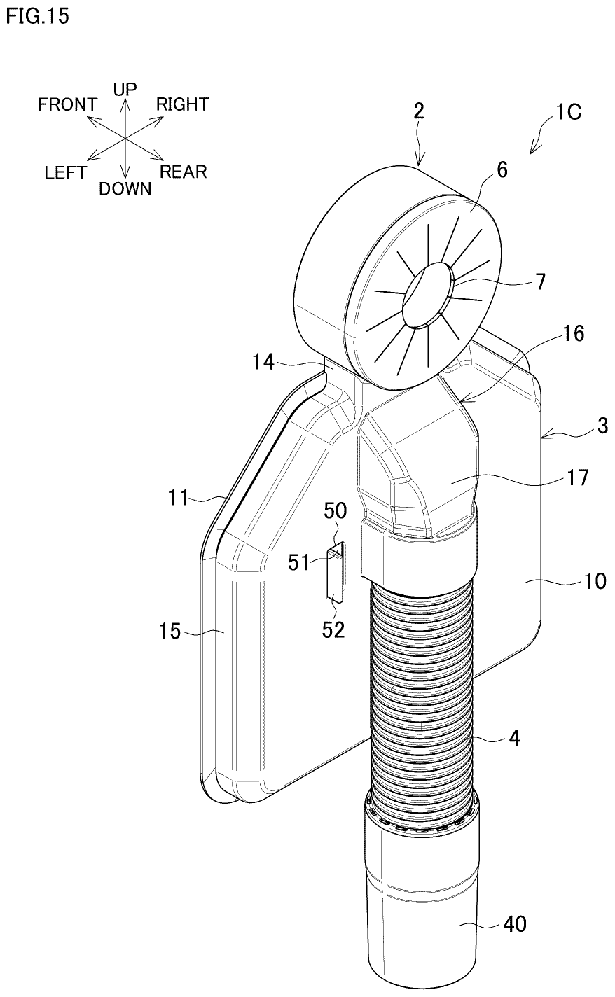

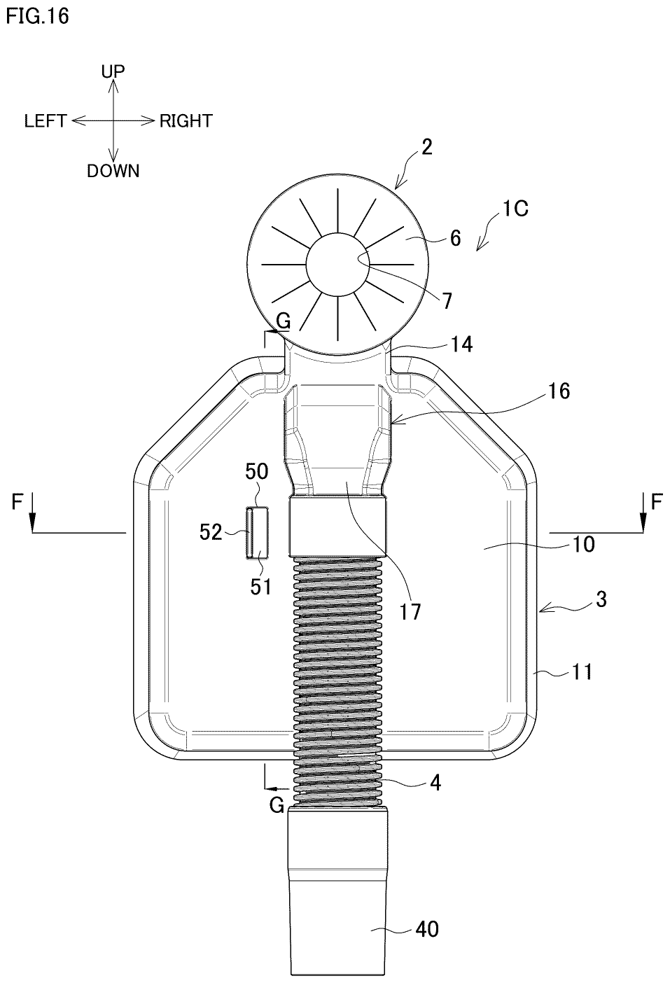

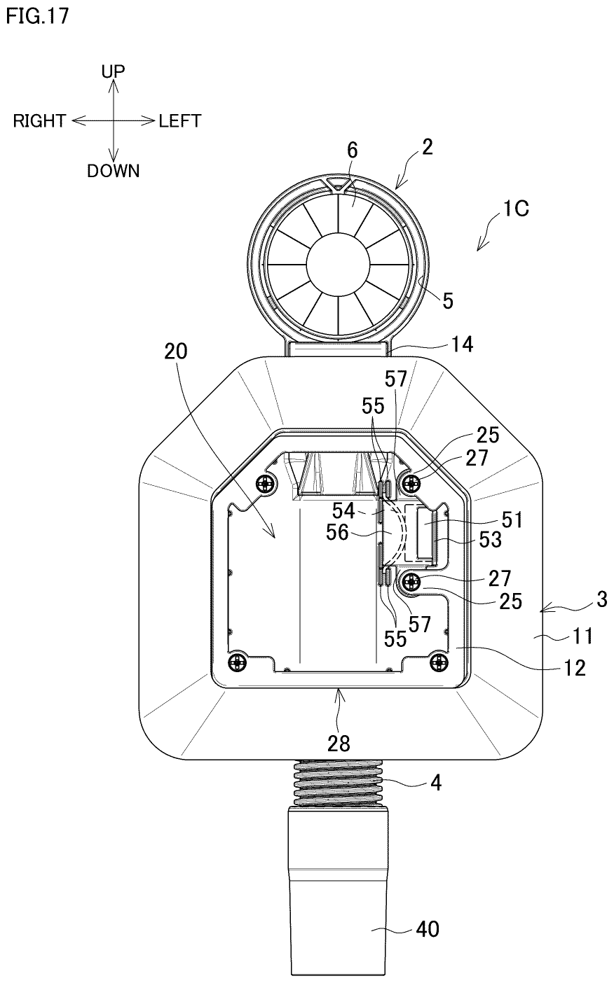

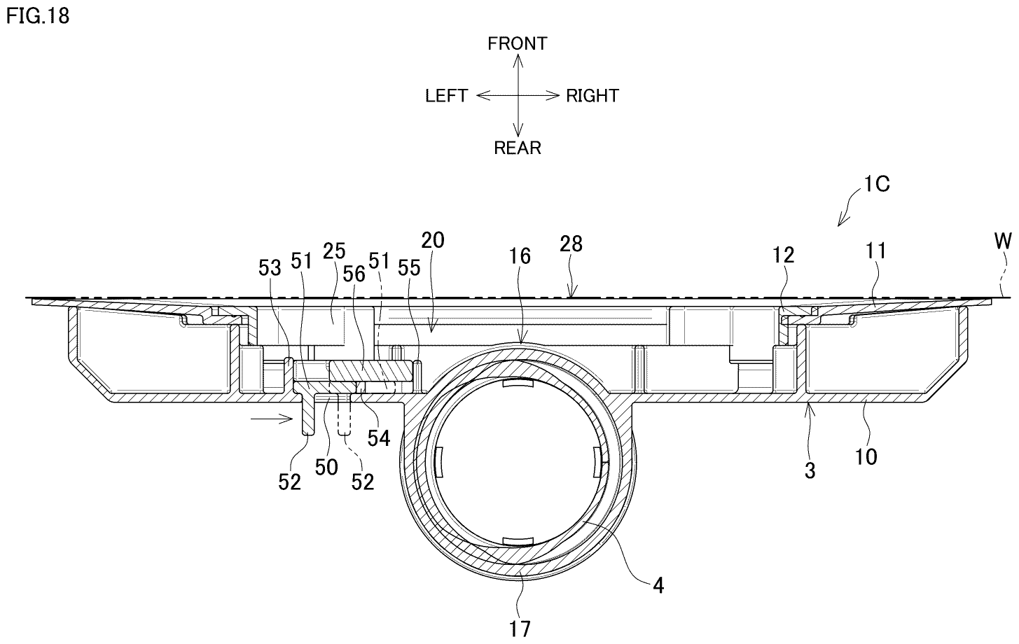

FIG. 15 a rear perspective view illustrating one example of a dust collecting attachment 1C of the fourth embodiment, FIG. 16 is a rear view thereof, FIG. 17 is a front view thereof, and FIG. 18 is an enlarged cross-sectional view of the line F-F in FIG. 16.

In the dust collecting attachment 1C, an air vent hole 50 is formed on the left side of the handle portion 17, not on the left and right sides of the handle portion 17, and is vertically long rectangular as viewed from the front. An air vent lever 51 is disposed on the front side of the air vent hole 50. The air vent lever 51 is a vertically long rectangular plate as viewed from the front, which is larger than the air vent hole 50. On a rear surface of the air vent lever 51, a flat plate-shaped lever portion 52 protruding rearward through the air vent hole 50 is formed in the up-down direction.

Guide ribs 53 extending along an outer circumference of the air vent lever 51 are protruded on a front face of the main body housing 10 above, below, and on the left side of the air vent lever 51. The guide ribs 53 allow the air vent lever 51 to slide between a left sliding position, namely a position indicated by the solid line in FIG. 18, which closes the air vent hole 50, and a right sliding position, namely a position indicated by the double-dotted chain line in FIG. 18, which opens the air vent hole 50. In the left sliding position, the lever portion 52 is in contact with a left end of the air vent hole 50.

A plate spring 54 is disposed on a right side of the air vent lever 51 on a front face of the main body housing 10. The plate spring 54 is supported at its upper and lower ends by upper and lower support ribs 55 protruded on the front surface of the main body housing 10, and bulges to a side of the air vent lever 51. The plate spring 54 is in contact with the air vent lever 51 and normally biases the air vent lever 51 to the left sliding position.

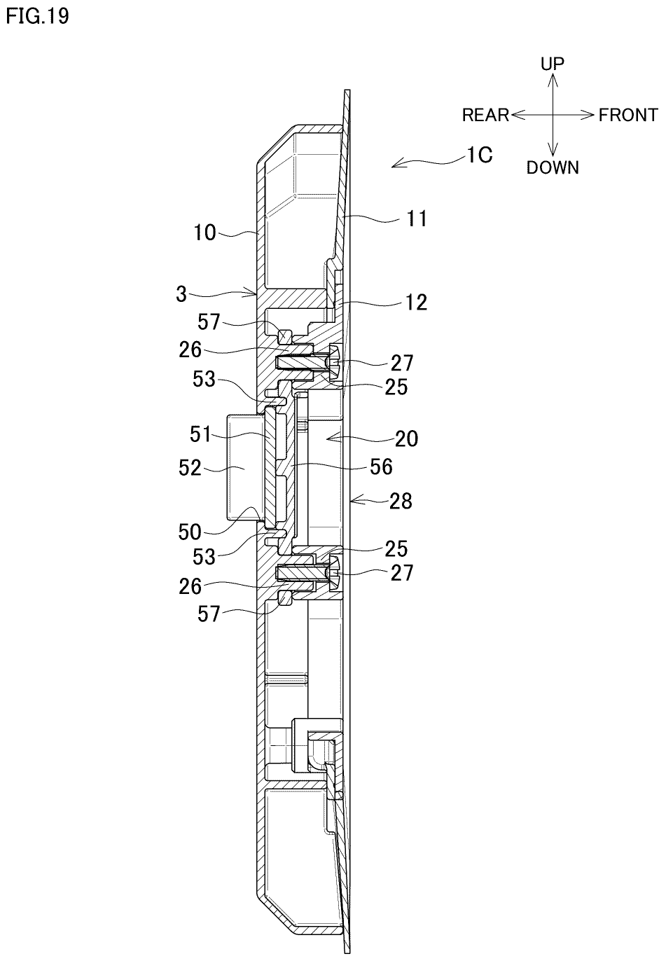

On a front side of the air vent lever 51 and the plate spring 54, a restraining plate 56 is disposed as also illustrated in FIG. 19. The restraining plate 56 is in contact with both the right side of the air vent lever 51 and a center portion of the plate spring 54 in a shape that spans the right side of the air vent lever 51 and the center portion of the plate spring 54. A pair of ring portions 57 are integrally formed at top and bottom of the restraining plate 56. The ring portions 57 are penetrated by the upper and lower screw bosses 26 for attaching the screw receivers 25 of the inner frame 12. The lower screw boss 26 is an addition from the first embodiment. When these upper and lower screw receivers 25 are secured with the respective screws 27, the screw receivers 25 contact the respective ring portions 57 from the forward, thereby restricting the forward movement of the restraining plate 56. Therefore, the air vent lever 51 and the plate spring 54 are also restricted from moving in the front-rear direction between the main body housing 10 and the restraining plate 56.

When removing the dust collecting attachment 1C, which has been adhered to the workpiece by suctioning, from the workpiece, the operator grasps the handle portion 17 with lever portion 52 on the left side. Then, as indicated by the double-dotted line in FIG. 18, the air vent lever 51 slides together with the lever portion 52 to the right sliding position against the biasing of the plate spring 54, thus opening the air vent hole 50. Then, since outside air flows into the suction space 20 through the air vent hole 50 while the suction force decreases, the dust collecting attachment 1C can be removed rearward from the workpiece W. This removal can be performed simultaneously with the operation of grasping the handle portion 17 and pulling it rearward.

In the dust collecting attachment 1C of the above-described fourth embodiment, the main body 3 is operated in the direction of removing the main body 3 from the workpiece W by grasping the handle portion 17 with the lever portion 52. In other words, the air vent by the air vent lever 51 and the removal of the dust collecting attachment 1C are not separate operations. Therefore, the dust collecting attachment 1C can be removed by a simple operation, and unintentional dropping thereof during the removal can be effectively avoided.

The following modification can be made to the dust collecting attachment 1C of the above-described fourth embodiment.

The air vent hole and the air vent lever may be disposed on the right side of the handle portion instead of the left side.

The shapes of the air vent hole and the air vent lever are not limited to a rectangular shape, but may be another shape such as square. The shape of the air vent lever may be different from that of the air vent hole, as long as the air vent hole can be closed.

The shape of the lever portion of the air vent lever can also be modified as needed. The lever portion may be curved outward in the right-left direction, for example, instead of being flat.

An elastic member that biases the air vent lever to the closed position is not limited to the plate spring, but another elastic member such as a coil spring can also be employed.

The shape and mounting structure of the restraining plate can also be modified as needed. The restraining plate can be screwed directly to the main body housing without using a screw boss.

The restraining plate may be omitted. In this case, the front end of the guide rib or the support rib may be bent into an L-shape to restrict the back and forth movement of the air vent operation portion such as the air vent lever.

A fifth embodiment of the disclosure is provided below.

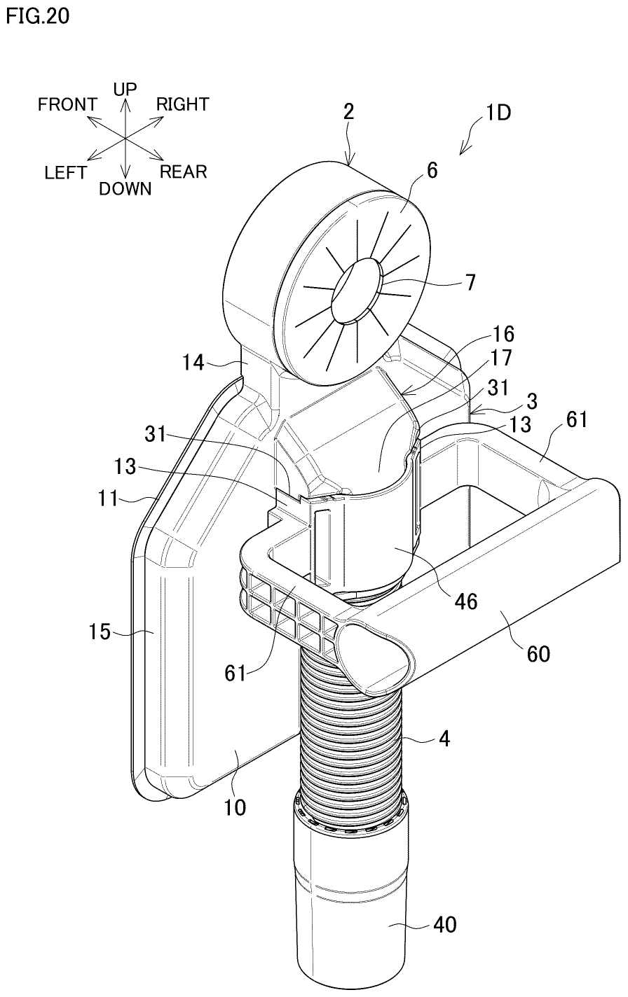

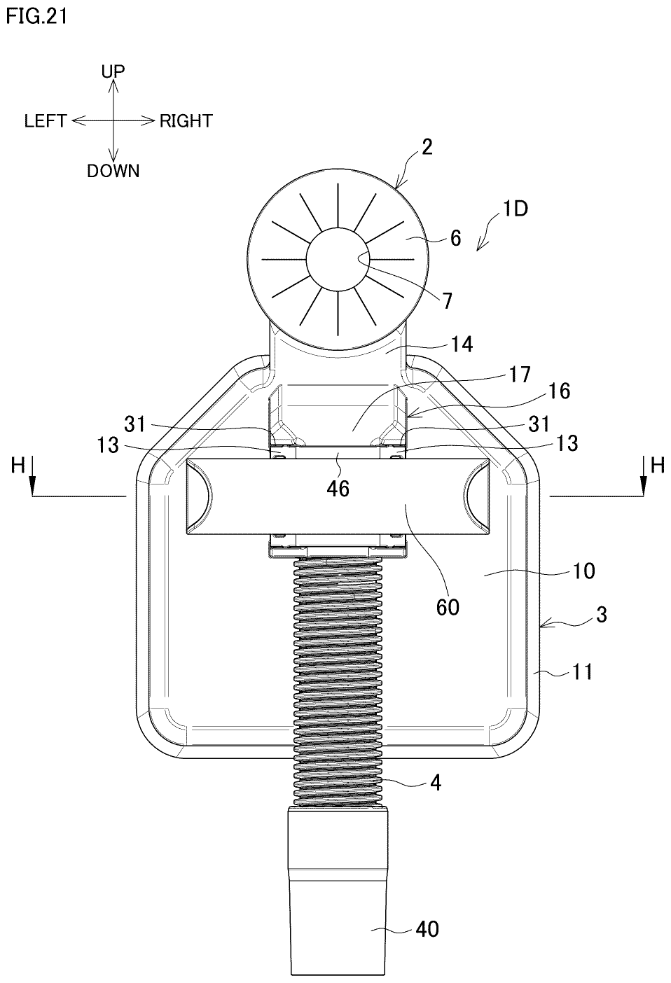

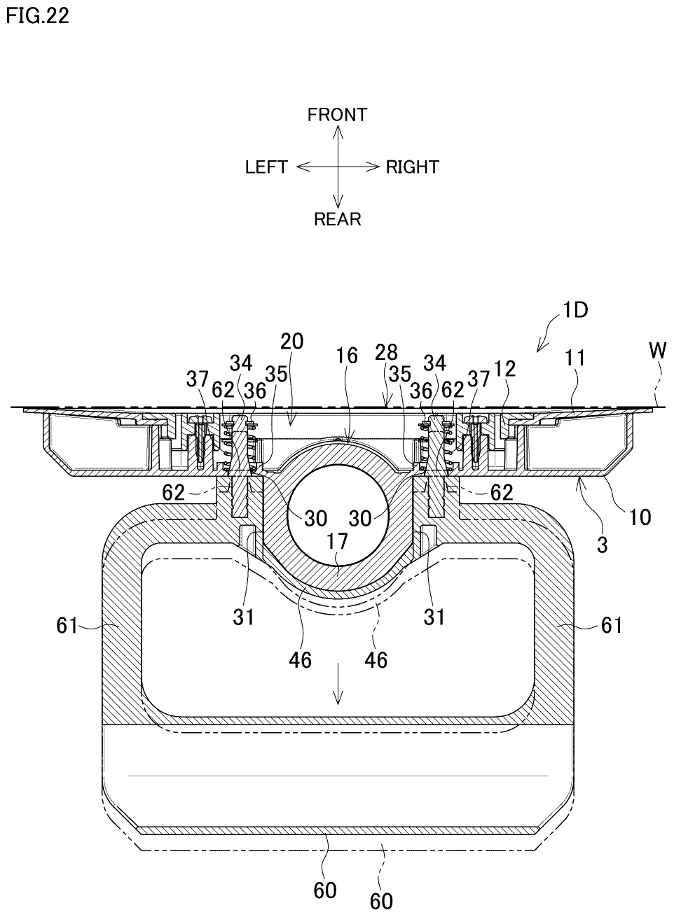

FIG. 20 is a rear perspective view of one example of a dust collecting attachment 1D of the fifth embodiment, FIG. 21 is a rear view thereof, and FIG. 22 is an enlarged cross-sectional view of the line H-H in FIG. 21.

The dust collecting attachment 1D differs from that of the first embodiment in that the right and left air vent levers 13 include a handle 60 connecting the both air vent levers 13, instead of the finger hook pieces. The handle 60 is rectangular in plan view, and front ends of right and left arms 61 are integrally connected to the respective air vent levers 13 to form a loop. The air vent levers 13 are connected by the bridging portion 46.

Here, the air vent lever 13 does not include a closure portion, and a tapered portion 62, which becomes larger in diameter as it goes rearward, is disposed at a middle portion of the guide pin 34. In the forward position of the air vent levers 13, large diameter portions at the rear end of the tapered portions 62 fit into the circular air vent holes 30 to close the air vent holes 30.

Therefore, when removing the dust collecting attachment 1D from the workpiece to change the machining position or the like, the operator grasps the handle 60 and pulls it rearward. Then, as indicated by the double-dotted line in FIG. 22, the air vent levers 13 and the tapered portions 62 retract against the biasing of the coil springs 37 and open the right and left cutouts 31 for opening the respective air vent holes 30. Then, since outside air flows into the suction space 20 through each air vent hole 30 while the suction force decreases, the dust collecting attachment 1D can be removed rearward from the workpiece W. This removal can be performed continuously with the operation of pulling the handle 60 rearward.

In the dust collecting attachment 1D of the above-described fifth embodiment, the air vent by the air vent lever 13 and the removal of the dust collecting attachment 1D are not separate operations. Therefore, the dust collecting attachment 1D can be removed by a simple operation, and unintentional dropping thereof during the removal can be effectively avoided.

In particular, since the air vent lever 13 includes the handle 60, the air vent operation by the air vent lever 13 and the removal operation of the dust collecting attachment 1D can be performed more easily by using the handle 60.

In the above-described fifth embodiment, the following modification can be made in addition to those applicable with the modifications in the above-described first embodiment.

The shape of the handle is not limited to the above examples. The handle may be of another shape, such as a semi-circular in plan view, for example. The handle may be connected to the bridging portion as an L-shaped or inverted T-shaped handle in plan view. However, the bridging portion can be omitted when it does not interfere with the installation of the handle.

The closure of the air vent hole is not limited to the tapered portion on the guide pin. As in the first embodiment, the closure portion may be disposed on the air vent lever. Conversely, in the first to third embodiments, the tapered portion may be disposed on the guide pin to close the circular air vent hole instead of the closure portion on the air vent lever.

A sixth embodiment of the disclosure is provided below.

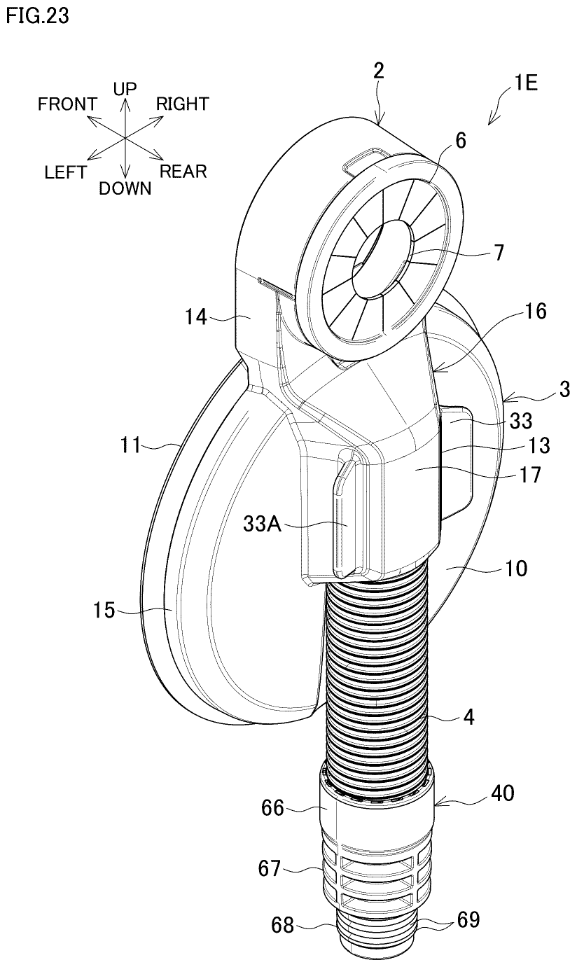

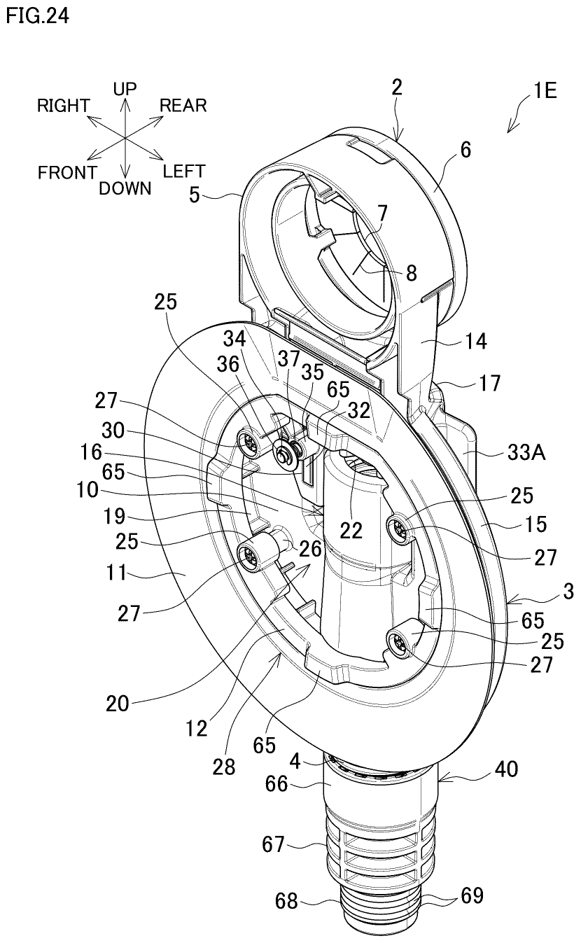

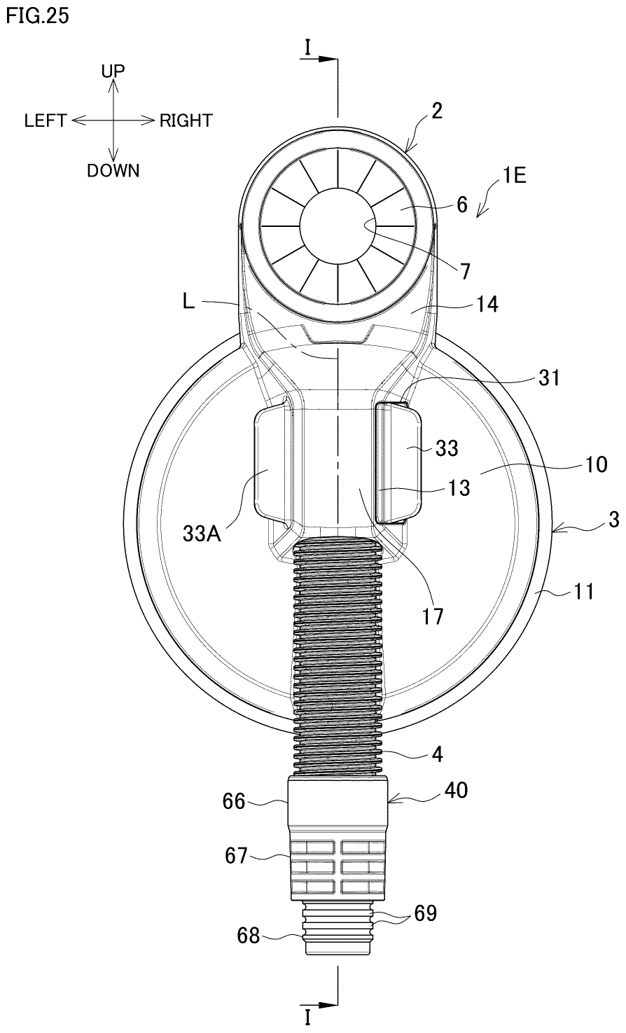

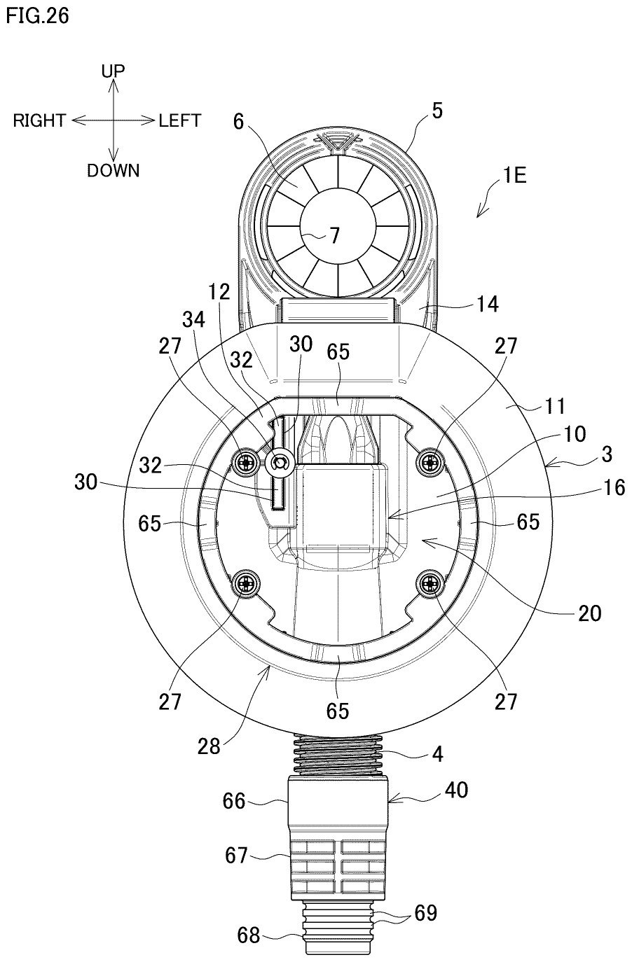

FIG. 23 is a rear perspective view of one example of a dust collecting attachment 1E of the sixth embodiment, and FIG. 24 is a front perspective view thereof. FIG. 25 is a rear view of the dust collecting attachment 1E, and FIG. 26 is a front view thereof.

As in the second embodiment, the dust collecting attachment 1E includes the upper and lower air vent holes 30 only on the right side instead of those in the pair of right and left. The main body housing 10 is circular as viewed from the rear. Therefore, the pad 11 and the inner frame 12 are also circular as viewed from the front, but the upper ends of the pad 11 and the inner frame 12 are chamfered as straight lines in the right-left direction.

Four contact portions 65 protruding forward, that is a side of the workpiece W, are formed at the front of the inner frame 12 on the top, bottom, left, and right sides thereof. The upper contact portion 65 extends in the right-left direction in accordance with a shape of the upper end of the inner frame 12. The other three contact portions 65 on the lower side and on the right and left sides extend in a circular arc along a circumference direction of the inner frame 12.

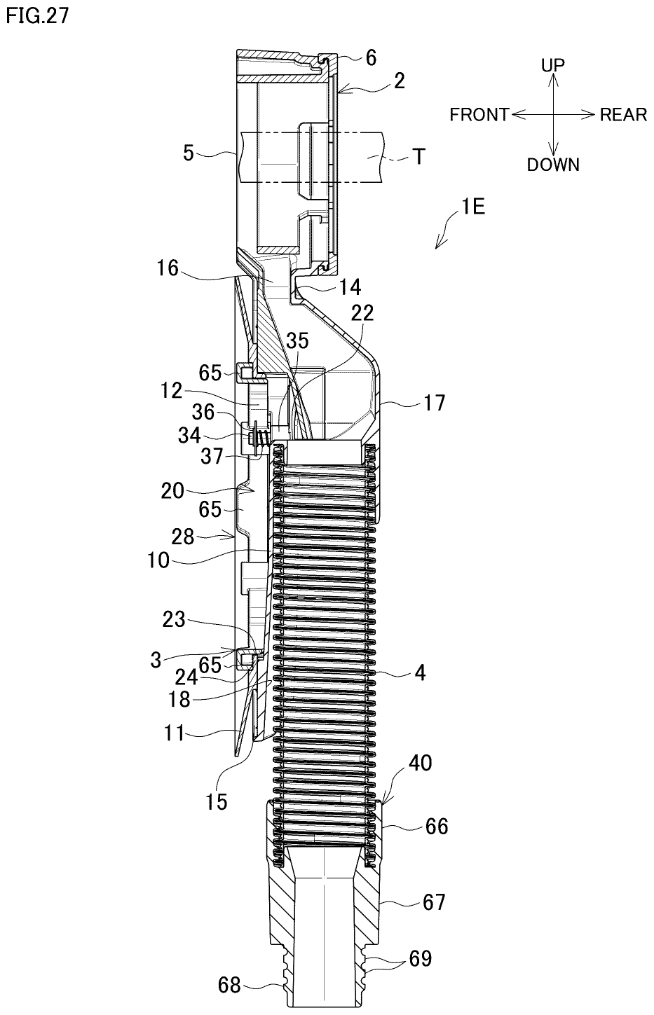

Each contact portion 65 is formed at a protruding height where the front surface is slightly rearward side of the front end surface of the pad 11 before the suction to the workpiece W, as illustrated in FIG. 27. In this state, a taper shaped portion of the pad 11 is disposed in a position where it does not contact the skirt portion 15 of the main body housing 10. A front surface of the contact portion 65 is one example of the protruding surface to the side of the workpiece in the contact portion of the present disclosure. A front end surface of the pad 11 is one example of the protruding surface to the side of the workpiece in the pad of the present disclosure.

On the other hand, the joint 40, which is connected to the flexible hose 4, has a three-stage diameter portion including a large diameter portion 66 with the largest diameter at the top, a medium diameter portion 67 in the middle, and a small diameter portion 68 with the smallest diameter at the bottom. On an outer circumference of the medium diameter portion 67, grooves are formed circumferentially for weight saving. On an outer circumference of the small diameter portion 68, a plurality of ring-shaped outer ribs 69 are formed in the axial direction.

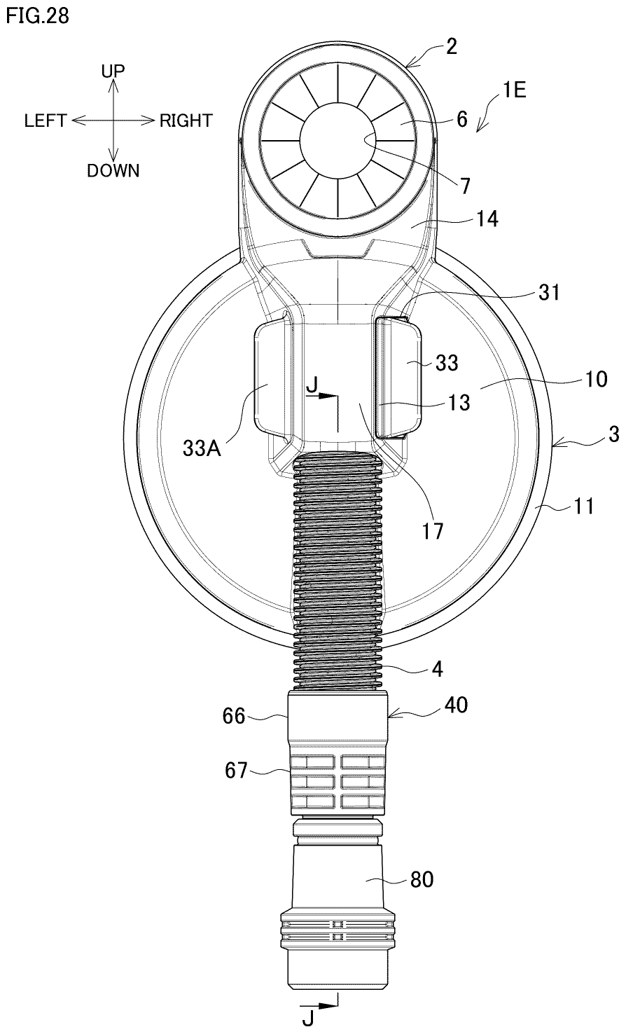

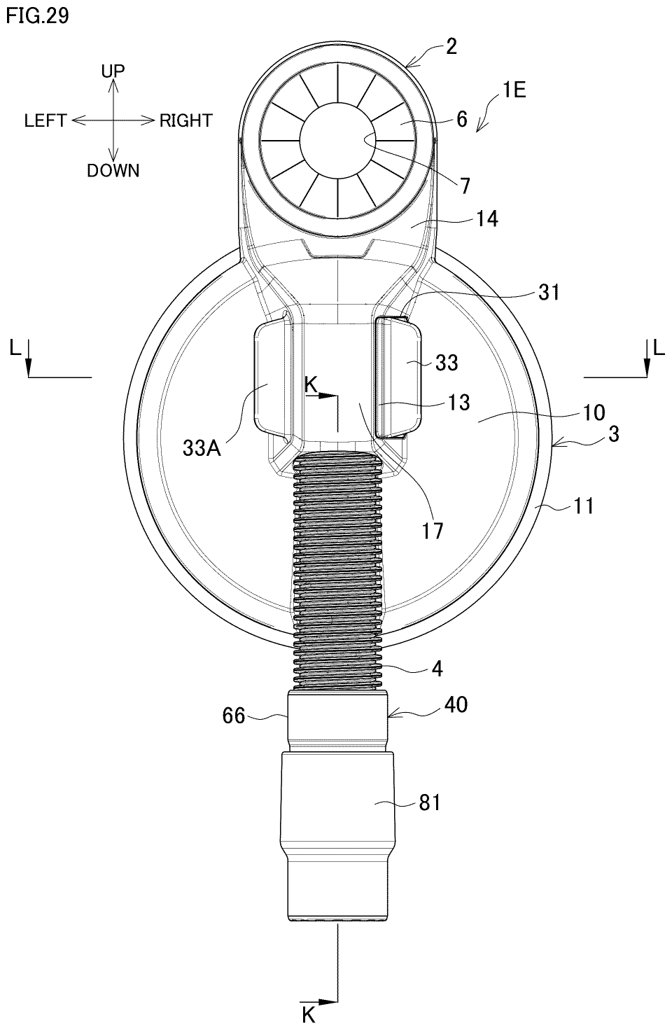

Thus, the joint 40 can be connected to any of a small diameter cuff 80 illustrated in FIG. 28 and a large diameter cuff 81 illustrated in FIG. 29.

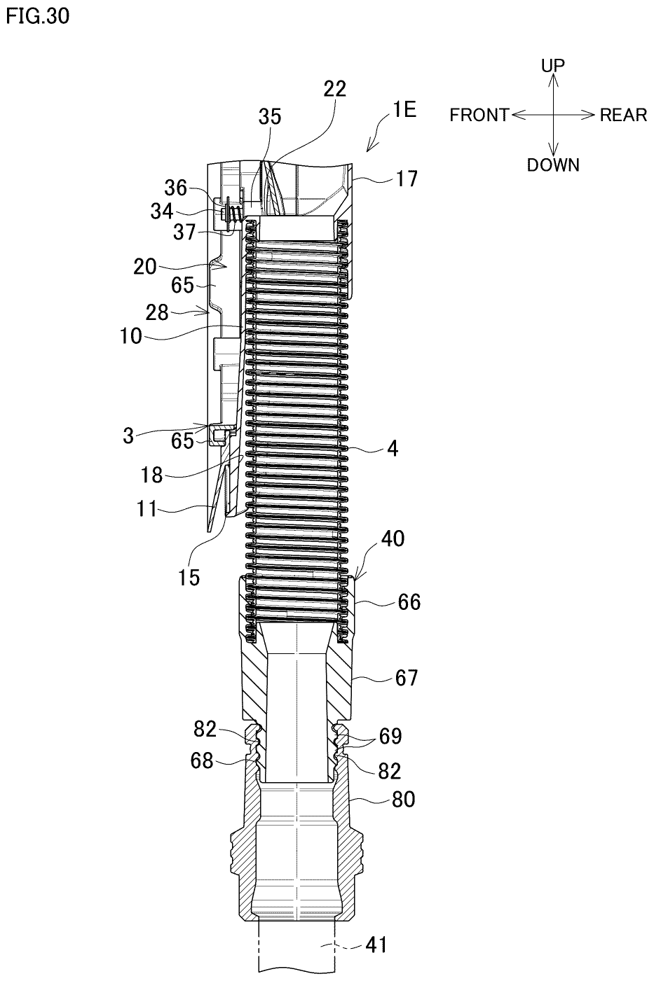

The small diameter cuff 80 can be connected by externally mounting its tip on the small diameter portion 68 as illustrated in FIG. 30. A plurality of ring-shaped inner ribs 82 are formed on an inner circumference surface of the cuff 80 in the axial direction. The inner ribs 82 are engaged between the outer ribs 69 when connected to the small diameter portion 68 so as to create a retaining action.

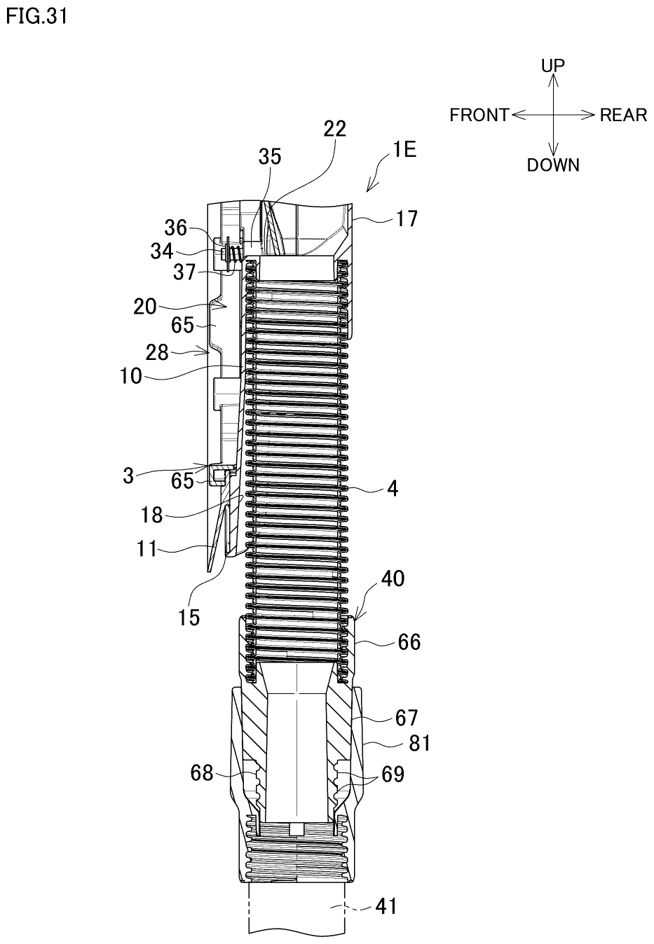

The large diameter cuff 81 can be connected by externally mounting and pushing its tip into the medium diameter portion 67 in front of the large diameter portion 66 as illustrated in FIG. 31.

Thus, the operator can use one joint 40 regardless of whether the tip of the external hose 41 is the cuff 80 or the cuff 81, eliminating the need to use a different joint 40 for each of the cuff 80 or the cuff 81.

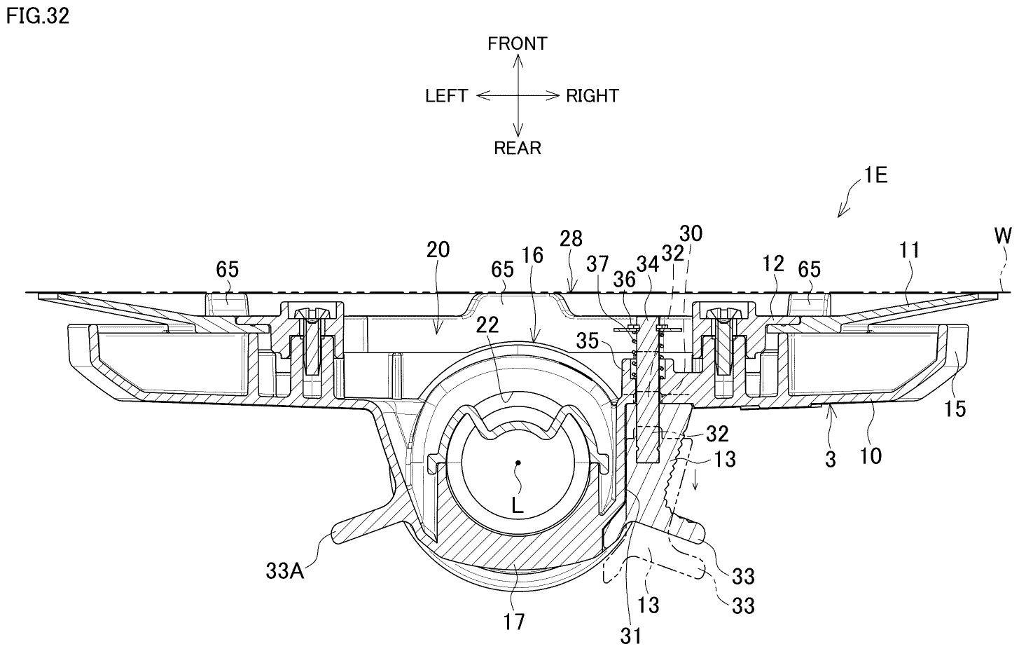

When the operator works by adhering the main body 3 by suction onto the surface of the workpiece W, each contact portion 65 of the inner frame 12 contacts the surface of the workpiece W with its front surface to restrict further advancement of the main body housing 10 as illustrated in FIG. 32. Therefore, the pad 11 is no longer crushed with the skirt portion 15 of the main body housing 10, and the pad 11 is maintained in non-contact with the skirt portion 15.

While the pad 11 is in contact with the skirt portion 15, when the surface of the workpiece W has a protruding shape, the skirt portion 15 together with the pad 11 rides up on the protruding portion and widens the gap between the pad 11 and the surface of the workpiece W, which may reduce the suction force.

However, here, the contact portion 65 regulates the forward position of the main body housing 10 to maintain the non-contact state between the pad 11 and the skirt portion 15. Therefore, even when the surface of the workpiece W has a protruding shape, only the pad 11 deforms, restricting the main body housing 10 from lifting and reducing the suction force.

On the other hand, when removing the dust collecting attachment 1E from the workpiece W to change the machining position or the like, the operator hooks his/her fingers on the finger hook piece 33 of the air vent lever 13 on the right side of the handle portion 17 and a finger hook piece 33A on the left side of the handle portion 17 from the front side and pulls them rearward as it is. Then, as indicated by the double-dotted line in FIG. 32, the right side air vent lever 13 retracts against the biasing of the coil spring 37 and opens the right side cutout 31 for opening the respective air vent holes 30. Then, since outside air flows into the suction space 20 through each air vent hole 30 while the suction force decreases, the dust collecting attachment 1E can be removed rearward from the workpiece W. This removal can be performed continuously with the operation of pulling the air vent lever 13 rearward via the finger hook piece 33.

In the dust collecting attachment 1E of the above-described sixth embodiment, the air vent by the air vent lever 13 and the removal of the dust collecting attachment 1E are not separate operations. Therefore, the dust collecting attachment 1E can be removed by a simple operation, and unintentional dropping thereof during the removal can be effectively avoided.

In particular, the main body 3 includes the main body housing 10 in which the dust collection passage 16, the suction space 20, the air vent hole 30, and the air vent lever 13 are disposed; the ring-shaped inner frame 12 disposed on the front side of the main body housing 10; the pad 11 made of elastic material that surrounds the outer circumference of the inner frame 12 and protrudes forward to form the suction port 28.

The inner frame 12 includes the contact portion 65 that protrudes forward with respect to the main body housing 10 and contacts the workpiece W when the suction port 28 is suctioned to the workpiece W.

Therefore, even when the surface of the workpiece W is uneven, it can be absorbed by the deformation of the pad 11, restricting the main body housing 10 from lifting up and thus avoiding the reduction in the suction force.

With the suction port 28 not adhered to the workpiece W by suction, the front surface of the contact portion 65 is positioned on the main body housing 10 side, rather than the front end surface of the pad 11.

Therefore, the contact portion 65 does not inhibit the pad 11 from adhering to the surface of the workpiece W.

In the above-described sixth embodiment, the following modification can be made in addition to those applicable with the modifications in the second embodiment above.

The number and shape of the contact portions may be modified as needed. For example, the contact portions may be extended longer in the circumferential direction of the inner frame than in the above example, or conversely, they may be shortened.

In the above example, the front surface of the contact portion is positioned slightly behind the front end face of the pad before the suction, but the front surface of the contact portion may be positioned on the same plane as the front end face of the pad before the suction, which is the plane defined by the up-down and right-left directions.

The contact portion is not limited to application to the dust collecting attachments including the air vent holes and the air vent operation portions as in the above example.

Specifically, the contact portion is applicable to the following the dust collecting attachment. The dust collecting attachment includes the dust suction portion and the main body. The dust suction portion has the suction opening through which the tip tool is allowed to pass. The main body includes the dust collection passage that is communicated with the dust suction portion and is connectable to the external hose, and the suction space that is communicated with the dust collection passage and has the suction port opening to a workpiece. The main body includes the main body housing that has the dust collection passage and the suction space, and the pad that is made of elastic material, is disposed on the main body housing, and protrudes to the side of the workpiece to form the suction port.

In this case, the contact portion may be disposed on the main body housing other than the inner frame, not limited to the above example with the inner frame, as long as the contact portion protrudes to the workpiece side and contacts the workpiece while the suction port contacts the workpiece in the suction state.

The joint can be modified to accommodate the cuff shape of the hose at the dust collector side. For example, it can be made connectable to three or more types of the cuffs by increasing the number of tiers with different diameters. The connection between the joint and the cuff is not limited to connection by rib-to-rib engagement or push-in. For example, screw connection and bayonet connections can also be employed as connection structures.

In common with each example, the following modification can be made.

The shapes of the dust suction portion and the main body can be modified as needed. For example, the main body can be square, rectangular, triangular, or elliptical in shape, as well as polygonal or circular as viewed from the rear.

The shape of the suction port can also be modified as needed.

The shapes and mounting structures of the pad and inner frame can also be modified as needed.

The flexible hose may be omitted. In this case, the external hose can be connected directly to the lower end of the handle portion.

In each example, the dust collecting attachment is assumed to be adhered on the workpiece by suction in the vertical direction, but the dust collecting attachment of the present disclosure can be used even when the workpiece is inclined or horizontal direction.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A dust collecting attachment comprising:
a dust suction portion having a suction opening through which a tip tool is allowed to pass; and
a main body having a dust collection passage communicated with the dust suction portion and connectable to an external hose, wherein
the main body includes:
a suction space that is communicated with the dust collection passage and has a suction port opening to a workpiece;
an air vent hole that opens the suction space to outside; and
an air vent operation portion that normally closes the air vent hole and opens the air vent hole by a predetermined operation, wherein
the air vent operation portion is operated together with an operation of removing the main body from the workpiece to open the air vent hole.

2. The dust collecting attachment according to claim 1, wherein
an operating direction of the air vent operation portion is the same as a direction in which the main body is removed from the workpiece.

3. The dust collecting attachment according to claim 1, wherein
the air vent operation portion includes a finger hook portion.

4. The dust collecting attachment according to claim 3, wherein
a portion of the dust collection passage forms a handle portion that bulges on a surface of the main body and extends in a straight line in a predetermined direction, and
wherein the air vent operation portion is disposed on the handle portion.

5. The dust collecting attachment according to claim 4, wherein
a pair of the air vent operation portions are disposed on both sides of a center line of the handle portion.

6. The dust collecting attachment according to claim 5, wherein
the pair of air vent operation portions are connected as one unit.

7. The dust collecting attachment according to claim 4, wherein
the air vent operation portion is disposed at one location.

8. The dust collecting attachment according to claim 7, wherein
the air vent operation portion is disposed on any one of both sides of a center line of the handle portion, and the finger hook portion is disposed on the handle portion on an opposite side of the air vent operation portion across the handle portion.

9. The dust collecting attachment according to claim 4, wherein
the external hose is connectable to the handle portion.

10. The dust collecting attachment according to claim 4, wherein
the air vent operation portion does not protrude from an outer shape of the handle portion except for the finger hook portion when the air vent hole is closed.

11. The dust collecting attachment according to claim 1, wherein
the air vent operation portion includes a handle.

12. The dust collecting attachment according to claim 1, wherein
the air vent operation portion is normally biased by a biasing member to a position that closes the air vent hole.

13. The dust collecting attachment according to claim 12, wherein
the air vent operation portion has an integral pin member that passes through the main body and is guided by the pin member for allowing linear movement between a position for closing the air vent hole and a position for opening the air vent hole, and
the biasing member biases the air vent operation portion to the position for closing the air vent hole via the pin member.

14. The dust collecting attachment according to claim 13, wherein
a pair of the air vent holes are formed around the pin member, and
the air vent operation portion includes a pair of closure portions that close the pair of air vent holes at the position for closing the air vent holes.

15. The dust collecting attachment according to claim 1, wherein
the main body includes a main body housing having the dust collection passage, the suction space, the air vent hole, and the air vent operation portion and a pad made of elastic material, disposed on the main body housing, and protruding to a side of the workpiece to form the suction port,
the main body housing includes a contact portion protruding to the side of the workpiece and contacting the workpiece in a state where the suction port is suctioned to the workpiece.

16. The dust collecting attachment according to claim 15, further comprising
a ring-shaped inner frame on the side of the workpiece of the main body housing, wherein the contact portion is disposed on the inner frame.

17. The dust collecting attachment according to claim 16, wherein
the pad has a tapered shape that increases in size from a side of the main body housing to the side of the workpiece, and a thin walled portion at the opening on the main body housing side is secured to the main body housing via the inner frame.

18. A dust collecting attachment comprising:
a dust suction portion having a suction opening through which a tip tool is allowed to pass; and
a main body having a dust collection passage communicated with the dust suction portion and connectable to an external hose and having a suction space that is communicated with the dust collection passage and has a suction port opening to a workpiece, wherein
the main body includes a main body housing having the dust collection passage and the suction space and a pad made of elastic material, disposed on the main body housing, and protruding to a side of the workpiece to form the suction port, and
the main body housing includes a contact portion protruding to the side of the workpiece and contacting the workpiece in a state where the suction port is suctioned to the workpiece.

19. The dust collecting attachment according to claim 18, further comprising
a ring-shaped inner frame on the side of the workpiece of the main body housing, and the contact portion is disposed on the inner frame.

20. The dust collecting attachment according to claim 18, wherein
when the suction port is not suctioned to the workpiece, a protruding surface of the contact portion at the side of the workpiece is positioned on a same plane as the protruding surface of the pad at the side of the workpiece or at a side of the main body housing with respect to the protruding surface of the pad.
